(19) United States
(12) Patent Application Publication
(10) Pub. No.: US 2005/0119025 A1
(43) Pub. Date: Jun. 2, 2005

(54) Serial digital interface for wireless network radios and baseband integrated circuits

(76) Inventors: Rishi Mohindra, Milpitas, CA (US); Serge Drogi, Phoenix, AZ (US); Hans Dropmann, Emerald Hills, CA (US); Vikas Vinayak, Mountain View, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/988,362

(22) Filed: Nov. 12, 2004

Related U.S. Application Data
(63) Continuation-in-part of application No. 10/727,230, filed on Dec. 2, 2003.
(60) Provisional application No. 60/556,312, filed on Mar. 24, 2004.

(51) Int. Cl. H04B 1/44; H04B 1/40; H04M 1/00

(52) U.S. Cl. 455/552.1; 455/88; 455/78; 455/550.1

(57) ABSTRACT

A wireless radio for wireless networking communication systems includes a radio frequency (RF) transceiver integrated circuit (IC) and a baseband digital signal processing (DSP) IC. A bidirectional serial digital interface couples data between the RF transceiver IC and the DSP IC to provide a high data rate and low noise. The bidirectional serial digital interface includes a first serial data connection and a second serial data connection. In one embodiment, the RF transceiver IC has a single bit sigma delta A/D modulator to convert an analog signal into a first serial digital bit stream for communication over the first serial data connection. In one embodiment, the DSP IC has a single bit sigma delta digital modulator to generate a second serial digital bit stream for communication over the second serial data connection.

### CROSS REFERENCE TO RELATED APPLICATIONS

This non-provisional United States (U.S.) patent application claims the benefit of U.S. Provisional Application No. 60/556,312 filed on Mar. 24, 2004 by inventors Rishi Mohindra et al., entitled “SIGMA-DELTA A/D AND SIGMA-DELTA DIGITAL INTERFACE FOR WIRELESS LAN RADIO AND BASEBAND INTEGRATED CIRCUITS” and further claims the benefit of and is a continuation in part (CIP) of U.S. patent application Ser. No. 10/727,230, filed on Dec. 2, 2003 by inventors Serge Drogi et al., entitled “METHOD, APPARATUS, AND SYSTEMS FOR DIGITAL RADIO COMMUNICATION SYSTEMS” which is incorporated herein in its entirety by reference, both of which are to be assigned to Maxim Integrated Products, Inc.

### FIELD OF THE INVENTION

The embodiments of the invention generally relate to wireless networking communication systems. The embodiments of the invention more particularly relate to modulating serial digital interfaces between radio receiver, transmitter, and transceiver integrated circuits and digital baseband integrated circuits for a wireless networking communication system.

### BACKGROUND OF THE INVENTION

In a typical radio architecture, the interface between the radio operating at carrier frequencies and the baseband section operating around the signal frequencies is typically an analog signal interface. The analog signal interface was typically preferred over a traditional digital signal interface because it avoided the use of parallel digital signals operating at high frequencies that could otherwise generate noise and interfere with the radio operation.

The radio typically consisted of one or more analog integrated circuits that included active analog filters specifically designed for only one radio transmission standard of a communication system. That is, the active analog filters were dedicated to one communication system and were not adaptable to differing communication system standards. Moreover, the active analog filters consumed power and required considerable silicon area within the integrated circuit.

If most, if not all, active analog filters can be eliminated from the analog integrated circuits of the radio, power can be conserved and die size reduced, leading to lower costs and increased battery usage time in battery operated devices.

Additionally in a receive channel, multi-bit parallel analog to digital converters are often used to convert a baseband analog signal into a parallel binary value representing a digital number. The digital number may then be processed by a digital signal processor. In a transmit channel, multi-bit parallel digital to analog converters may be used. However, the multi-bit parallel analog to digital converters and multi-bit parallel digital to analog converters require significant area over an integrated circuit. Additionally, multi-bit parallel analog to digital converters and multi-bit parallel digital to analog converters are usually manufactured using special silicon manufacturing processes as they are mixed signal devices. The silicon manufacturing processes employed effects the cost of a radio. By eliminating a multi-bit parallel analog to digital converter device and a multi-bit parallel digital to analog converter device, the cost of the radio may be further reduced.

### BRIEF SUMMARY OF THE INVENTION

The embodiments of the invention are briefly summarized by the claims. [In one embodiment, a wireless radio for wireless networking communication systems is provided. The wireless radio includes a radio frequency transceiver integrated circuit to receive a first wireless network radio signal and to transmit a second wireless network radio signal; a processor integrated circuit to decode data from the first wireless network radio signal and to encode data for the second wireless network radio signal; and a bidirectional serial digital interface between the radio frequency transceiver integrated circuit and the processor integrated circuit. The bidirectional serial digital interface has a first serial data connection to couple serial digital data from the radio frequency transceiver integrated circuit to the processor integrated circuit, and a second serial data connection to couple serial digital data from the processor integrated circuit to the radio frequency transceiver integrated circuit.

In another embodiment, a wireless adapter for wireless networking communication systems is provided. The wireless adapter has a radio frequency transceiver integrated circuit and a processor. The radio frequency transceiver integrated circuit includes a modulating analog to digital converter, an output driver, an input receiver, a data recoverer, a low pass filter, a mixer, and an amplifier. An analog input of the modulating analog to digital converter receives a wireless network radio signal. The output driver has an input coupled to the serial digital output of the modulating analog to digital converter and a digital output. The input receiver has a digital input and a serial digital output. The data recoverer has an input coupled to the serial digital output of the input receiver and a serial digital output, The low pass filter has an input coupled to the serial digital output of the data recoverer and has an analog output. The mixer has an input coupled to the analog output of the low pass filter and an analog output. The amplifier has an input coupled to the analog output of the mixer and an output to couple to an antenna to transmit a wireless network radio signal. The processor is coupled to the digital output of the output driver and the digital input of the input receiver of the radio frequency transceiver integrated circuit.

In another embodiment, a wireless radio transceiver for wireless networking communication system is provided. The wireless radio transceiver includes an antenna, a radio frequency transceiver integrated circuit coupled to the antenna, and a digital signal processing integrated circuit coupled to the radio frequency transceiver integrated circuit. The antenna extracts a first wireless network radio signal broadcast from at least one wireless access point in order to receive an analog input signal and radiates a second wireless network radio signal to the at least one wireless access point in order to transmit an analog output signal. The radio frequency transceiver integrated circuit includes a single bit modulator to convert the analog input signal into a first serial digital bit stream, and a low pass filter to convert a second serial digital bit stream into the analog output signal. The digital signal processing integrated circuit receives the first serial digital bit stream and decoded a digital signal therefrom. The digital signal processing integrated circuit further encodes a digital signal into the second serial digital bit stream for transmission to the radio frequency transceiver integrated circuit.

In yet another embodiment, a radio frequency integrated circuit couples to an antenna to transmit and to receive wireless network signals. The radio frequency integrated circuit includes a first amplifier, a down converter, a single bit modulator, a differential output driver, a differential input receiver, a low pass filter, a mixer, and a second amplifier. The first amplifier has an input to couple to an antenna to receive a first wireless network signal and generates a first analog signal on its output in response thereto. The down converter has an input coupled to the output of the first amplifier to extract a second analog signal from the first wireless network signal. The single bit modulator has an input coupled to the output of the first amplifier to convert the first analog signal into a serial digital bit stream on its output. The differential output driver has an input coupled to the output of the single bit modulator to drive the serial digital bit stream onto a differential output. The differential input receiver has a differential input to receive and form a second serial digital bit stream at its output. The low pass filter has input coupled to the output of the differential input receiver and converts the second serial digital bit stream into a second analog signal on its output. The mixer has an input coupled to the output of the low pass filter and up-converts the second analog signal from a baseband frequency to a wireless network carrier frequency as the second wireless network radio signal at its output. The second amplifier has an input coupled to the output of the mixer and amplifies the second wireless network radio frequency signal at its output for radiation by an antenna.

In yet another embodiment, a system is provided that has a radio frequency integrated circuit and a processor. The radio frequency integrated circuit includes a single bit sigma delta modulator and an output driver. The single bit sigma delta modulator has an analog input to convert an analog input signal thereon received from a wireless network into a first serial digital bit output stream on its single digital bit output. The output driver has an input coupled to the single digital bit output of the single bit analog to digital converter to drive the first serial digital bit stream onto its output. The processor is coupled to the output of the output driver of the radio frequency integrated circuit to receive the first serial digital bit stream and recover a first digital data signal therefrom.

In still another embodiment, a wireless networking communication system is provided that includes at least one wireless access point and at least one wireless communication device to communicate with the at least one wireless access point using the wireless network signals. The at least one wireless access point is coupled to a wired network backbone and has a first antenna to transmit and to receive wireless network signals within a limited area over at least one carrier frequency. The at least one wireless communication device has a second antenna to transmit and to receive the wireless network signals within the limited area, a radio frequency integrated circuit coupled to the second antenna, and a digital signal processing integrated circuit coupled to radio frequency integrated circuit. The radio frequency integrated circuit includes a single bit sigma delta modulator, a first output driver, a first input receiver, and a low pass filter. The single bit sigma delta modulator has an analog input and a first serial digital output and converts an analog input signal into a first serial digital bit stream. The first output driver has an input coupled to the first serial digital output and has a differential output. The first input receiver has a differential input to receive a second serial digital bit stream. The low pass filter has an input coupled to the output of the first input receiver, and converts the second serial digital bit stream into an analog output signal. The digital signal processing integrated circuit includes a second input receiver, a single bit sigma delta digital modulator, and a second output driver. The second input receiver has a differential input coupled to the differential output of the first output driver in order to receive the first serial digital bit stream. The single bit sigma delta digital modulator has a parallel digital input and a second serial digital output and converts a digital word input signal into the second serial digital bit stream. The second output driver has an input coupled to the second serial digital output and a differential output to couple to the differential input of the first input receiver.]

### BRIEF DESCRIPTION OF THE DRAWINGS

FIG. 1 is block diagram of an exemplary wireless communication system employing the invention.

FIG. 2A is block diagram of a wireless mobile radio unit, such as a mobile cellular telephone.

FIG. 2B is block diagram of a wireless stationary radio unit, such as a cellular telephone base station.

FIG. 3A is a block diagram of a system including a radio receiver integrated circuit (IC), a radio transmitter IC, and a baseband digital signal processing (DSP) IC.

FIG. 3B is a magnified block diagram of the radio receiver integrated circuit (IC).

FIG. 3C is a magnified block diagram of the radio transmitter integrated circuit (IC).

FIG. 3D is a magnified block diagram of the baseband digital signal processing (DSP) integrated circuit (IC).

FIG. 4 is a block diagram of an alternate embodiment of the system including a radio receiver integrated circuit (IC), a radio transmitter IC, and a baseband digital signal processing (DSP) IC.

FIG. 5 is a block diagram of another alternate embodiment of the system including a radio receiver integrated circuit (IC), a radio transmitter IC, and a baseband digital signal processing (DSP) IC.

FIG. 6A is a block diagram of a system including a radio transceiver integrated circuit (IC), and a baseband digital signal processing (DSP) IC.

FIG. 6B is a magnified block diagram of the radio transceiver integrated circuit (IC).

FIG. 6C is a magnified block diagram of the baseband digital signal processing (DSP) integrated circuit (IC).

FIG. 7 is a block diagram of an alternate embodiment of the system including a radio transceiver integrated circuit (IC) and a baseband digital signal processing (DSP) IC.

FIG. 8 is a block diagram of another alternate embodiment of the system including a radio transceiver integrated circuit (IC) and a baseband digital signal processing (DSP) IC.

FIG. 9A is a block diagram to illustrate details of a receive channel of a digital interface between a radio integrated circuit (IC) and a baseband digital signal processing (DSP) IC.

FIG. 9B is a block diagram to illustrate an alternate embodiment of clock generation and synchronization for the digital serial interface between a radio integrated circuit (IC) and a baseband digital signal processing (DSP) IC.

FIG. 10 is a graph illustrating a simulation of interference level of the digital interface in comparison to frequency bands of communication systems, data spectrum, and the clock spectrum.

[FIG. 11A is a diagram illustrating an exemplary wireless networking communication system.

FIG. 11B is a diagram illustrating differences between various wireless communication systems.

FIG. 11C is a diagram illustrating an exemplary wireless network adapter.

FIG. 12 illustrates a simplified functional block diagram of the radio frequency transceiver integrated circuit (IC) with a sigma-delta analog to digital modulator interfacing to a simplified functional block diagram of the baseband digital signal processing integrated circuit (IC) having a sigma-delta based digital to analog modulator.

FIG. 13A illustrates a functional block diagram of a sigma-delta analog to digital converter/modulator.

FIG. 13B illustrates a functional block diagram of a fourth order loop filter for the sigma-delta analog to digital converter/modulator of FIG. 13A.

FIG. 13C illustrates a functional block diagram of a sigma-delta analog to digital converter/modulator within the radio frequency transceiver integrated circuit (IC).

FIG. 14A illustrates a functional block diagram of a sigma-delta digital modulator.

FIG. 14B illustrates a functional block diagram of a second order loop filter for the sigma-delta digital modulator of FIG. 14A.

FIG. 14C illustrates a functional block diagram of a sigma-delta digital modulator within the baseband digital signal processing integrated circuit (IC).

FIG. 15A is a schematic of an exemplary inverting analog amplifier.

FIG. 15B is a schematic of an exemplary non-inverting analog amplifier.

FIG. 15C is a schematic of an exemplary four input analog summing amplifier.

FIG. 15D is a schematic of an exemplary analog integrator.

FIG. 15E is a schematic of an exemplary switched capacitor analog integrator.

FIG. 15F is a schematic of an exemplary analog sample and hold circuit.

FIG. 15G is a schematic of an exemplary D type flip flop element for a delay register.]

### DETAILED DESCRIPTION OF THE PREFERRED EMBODIMENTS

In the following detailed description of embodiments of the invention, numerous specific details are set forth in order to provide a thorough understanding. However, one skilled in the art would recognize that the embodiments of the invention may be practiced without these specific details. In other instances well known methods, procedures, components, and circuits have not been described in detail so as not to unnecessarily obscure aspects of the embodiments of the invention.

The embodiments of the invention include methods, apparatuses and systems for radio frequency integrated circuits and digital signal processing integrated circuits. The embodiments of the invention provide a new and optimized way to exchange received radio signals between a radio receiver integrated circuit and a digital processing circuit. The embodiments of the invention further provide new ways to exchange signals for transmission between a radio transmitter integrated circuit and a digital processing circuit.

[The embodiments of the invention are particularly applicable to wireless networking communication systems such as a wireless local area network (WLAN), a wireless metropolitan area network (WMAN), a wireless pan-access network (WPAN), a wireless fidelity (WiFi, IEEE 802.11 wireless networking standard) network, or a worldwide interoperability for microwave access (WiMax, IEEE 802.16 wireless broadband standard) network.] However, the embodiments of the invention may also be used in other types of radios. The embodiments of the invention simplify the physical interface (e.g., reduces the number of pins and thereby eases printed circuit board design), simplify the control layers (by providing a high dynamic range), enables multi-standard operation through software changes (flexible in that band changes, code changes, filter changes, mode changes, etc. can be made by software control), lowers costs, and conserves power.

The embodiments of the invention use a combination of analog to digital conversion, digital coding, high-speed digital interface and digital filtering to achieve transfer of information between two integrated circuits (ICs) over a serial digital bit stream. Received radio signals are converted to a digital format within the radio frequency IC. The digital format of the received radio signals are communicated to a digital processing IC over the high speed digital interface by means of the serial digital bit stream. The digital processing IC performs digital filtering and does no analog processing of the radio signal. The digital processing IC avoids costly analog processing blocks and therefore can be manufactured in lower cost digital manufacturing processes.

In one embodiment, the digital interface includes an analog to digital converter built as a sigma delta modulator with a single bit digital stream output, a low voltage differential signal transmitter, a matched differential line to provide a physical connection, and a low voltage differential signal receiver with subsequent digital data recovery and signal processing. The configuration of elements with the high speed digital interface between the radio IC and the digital processing IC enables high dynamic range signals to be transferred to the digital IC where they can be digitally filtered.

That is, the digital format chosen supports multiple data transfer rates, and thus applies to many different radio protocols, in particular it spans from narrow to wide band radio systems, and for example can be used for cellular phones from first generation to the latest wide band third generation standards. It also supports very high data rates, up to hundreds of mega-bits per second, and thus is suitable for transfer of softly filtered radio signals, which have a high dynamic range, requiring higher over-sampled data rates.

To support the digital interface, modulators/decimators are utilized. Multiple modulation/demodulation standards may be used including sigma-delta modulation/demodulation, also referred to as delta-sigma modulation/demodulation. In a preferred embodiment, the encoding of the signal is realized using a multi rate sigma-delta modulator with two levels of quantization, a single bit modulator, to generate a digital bit serial data stream.

The digital format being a low voltage differential signal and the coding generating a single digital bit serial data stream inherently provides low spurious radio emissions, which is important in any radio receiver. Moreover, a data rate clock does not need to be explicitly transmitted with the signal of the single digital bit serial data stream, thereby eliminating another source of spurious emission.

The digital format and coding chosen does not require the formatting of the information into parallel words and therefore there is no need for handshake synchronization to realize data transfer. Transferring data in parallel consumes power due to the output drivers having to drive high capacitive loads. Transferring data serially lowers current/power consumption. Moreover, fewer lines change state between integrated circuits, reducing another source of radio spurious emissions. Eliminating handshake synchronization signals also eliminates another source of radio spurious emissions and current/power consumption. Moreover, the number of pins used for the integrated circuit is reduced when serially transmitting data and avoiding the use of hand shake synchronization signals.

At a physical level, the digital interface uses low voltage differential signaling to provide low current/power consumption, high-speed data transfer, and low spurious emissions.

The digital interface optimizes power consumption within the complete radio transceiver system as it minimizes digital signal processing performed by radio frequency analog integrated circuits and minimizes analog signal processing performed by the digital signal processing integrated circuits. The radio frequency analog integrated circuits, which transceive the analog signals with an antenna, use Silicon manufacturing techniques optimized for analog processing. Silicon manufacturing techniques optimized for analog signal processing often have lower performance when used for digital signal processing, in comparison with Silicon manufacturing processes optimized for digital signal processing. Similarly, Silicon manufacturing techniques optimized for digital signal processing often have lower performance when used for analog signal processing, in comparison with Silicon manufacturing processes optimized for analog signal processing. The use of the disclosed digital interface between the RF analog integrated circuits and the baseband DSP integrated circuit, suppresses a need to perform analog signal processing in the baseband DSP integrated circuit and digital signal processing in the RF analog integrated circuits, easing their design and manufacture. Complex mixed signal circuits are avoided by employing the disclosed digital interface between the RF analog integrated circuits and the baseband DSP integrated circuit. The digital interface is provided to optimize the overall design and manufacture of the radio transceiver.

### Cellular Wireless Communication System

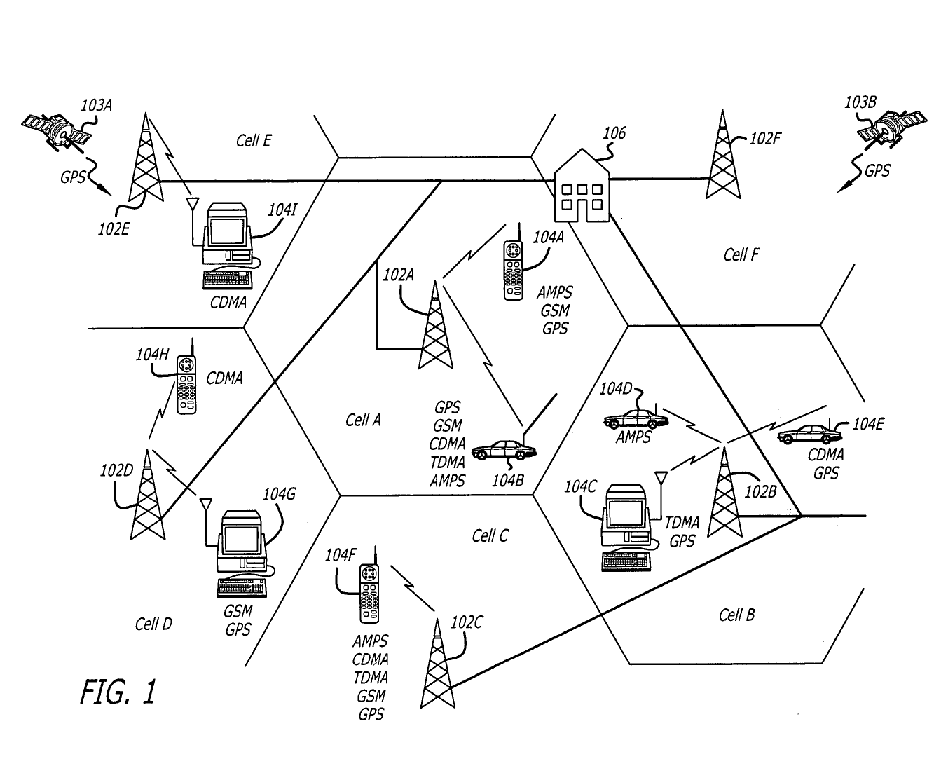

Referring now to FIG. 1, a block diagram of an exemplary wireless communication system is illustrated. The cellular communication system includes base stations 102A-102F, mobile devices or units 104A-104I and a switching center 106. Satellites 103A-103B may also be apart of the cellular communication system. The mobile devices or units 104A-104I may be cellular telephones, personal digital assistants, or portable computers, for example. The base stations 102A-102F and their one or more antennas form cell boundaries of cells A-F. The base stations 102A-102F may couple to the switching center 106 through intercellular trunk lines. The intercellular trunk lines may be fiber optic cables, wire cables, or microwave relay lines.

The cellular communication system illustrated in FIG. 1 is a multimode wireless communication system. One or more of the mobile devices may use differing methods of wireless communication with the base stations. That is, the radio frequency and modulation/demodulation at the physical link layer and the type of digital coding used at the data link layer may be different depending upon the type of wireless communication mode selected. For example, one or more communication systems with differing frequency bands, modulation, and channel coding may be used such as Universal Mobile Telecommunication System (UMTS), Global System for Multiple Communication (GSM), GSM Mobile Application Part (GSM-MAP), General Packet Radio Protocol System or General Packet Radio Service (GPRS), Enhanced Data GSM Environment (EDGE), (GAIT), Orthogonal Frequency-Division Multiplexing (OFDM), Code Orthogonal Frequency Division Multiplexing (COFDM), Block Coding, Convolutional Coding, Turbo Coding, Trellis Coding, Gaussian Minimum Shift Keying (GMSK), Quadrature Phase Shift Keying (QPSK), Quadrature Amplitude Modulation (QAM), Frequency Modulation (FM), Frequency Division Multiple Access (FDMA), Time Division Multiple Access (TDMA), Code Division Multiple Access (CDMA), Narrowband CDMA (N-CDMA), Wideband CDMA (W-CDMA), CDMA2000, CDMA2000-1XEV, CDMA2000-EVDO, CDMA2000-EDV, Time Division-Synchronized Code Division Multiple Access (TD-SCDMA), Third-Generation Partnership Project (3GPP TDD), International Mobile Telecommunication (IMT), IMT2000MC, IMT2000DS, IMT2000SC, IMT2000TC, Personal Communication System (PCS), Digital Communication System (DCS), Personal Digital Cellular (PDC), Digital Enhanced Cordless Telecommunications (DECT), Advanced Mobile Phone System (AMPS), Wireless Local Area Network (LAN) (IEEE 802.11a, IEEE 802.11b, IEEE 802.11g), and Global Positioning System (GPS) wireless communication systems. The base stations and mobile devices may support one or more of these as multimode (and/or multislot, multiband, multicode, multisystem) devices.

Consider the mobile devices 104H and 104G in cell D, for example. Wireless device 104H may wirelessly communicate with the base station 102D using a CDMA communication link while wireless device 104G may communicate with the base station 102D using a GSM communication link. As another example, consider wireless device 104F in cell C. The wireless device 104F is a multimode communication device and may communicate with the base station 102C using one or more types of wireless communication links such as AMPS, CDMA, TDMA, or GMS. The wireless device 104F may also communicate with the satellites 103A-103B using a GPS frequency band. As yet another example, consider wireless devices 104A and 104B in cell A. Wireless device 104A may communicate with the base station 102A using AMPS or GSM. The wireless device 104A may also communicate with the satellites 103A-103B using a GPS frequency band. Wireless device 104B may communicate with the base station 102A using one or more types of wireless communication links such as AMPS, CDMA, TDMA, or GMS. The wireless device 104A may also communicate with the satellites 103A-103B using a GPS frequency band. In this manner, the base stations may be shared by the differing communication links.

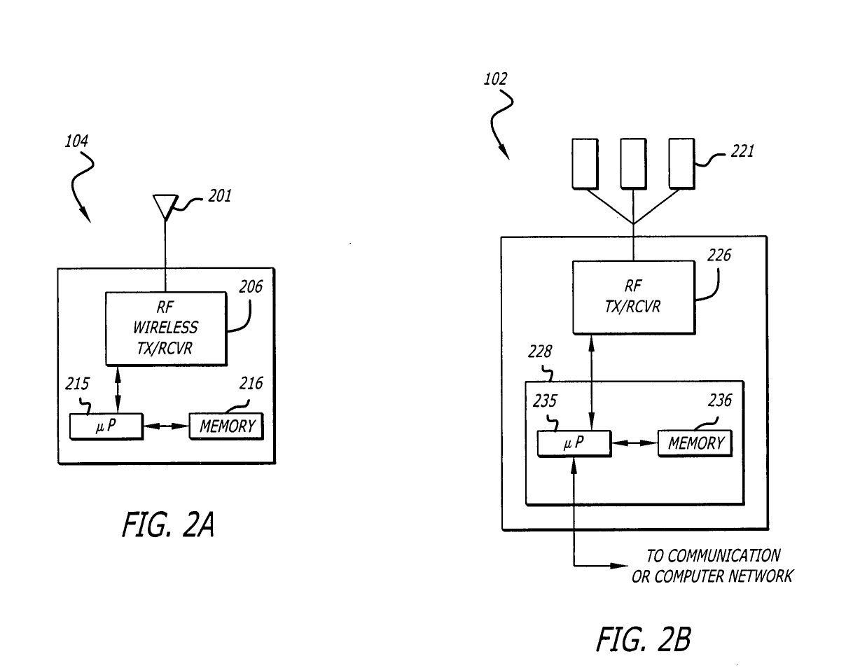

Referring now to FIG. 2A, a block diagram of a wireless mobile radio unit 104, such as a mobile cellular telephone, is illustrated. The wireless mobile radio unit 104 supports multicode, multislot, multimode, multiband, multisystem, and/or differing types of wireless communication modes. The wireless mobile radio unit 104 may be utilized in the multimode cellular communication system described previously with respect to FIG. 1 as well as the other different communication systems previously described.

The wireless mobile radio unit 104 includes an antenna 201, a radio frequency receiver/transmitter or transceiver 206, a microprocessor 215 and a memory 216. The radio frequency transceiver 206 is coupled to the antenna 201 to transmit and receive radio waves. The radio frequency transceiver 206 is a unified hardware component that can support multiple types of wireless communication systems and the multibands, multislots, multicodes, and multimodes, such as CDMA, GSM, TDMA, etc. The radio frequency transceiver 206 couples to the microprocessor 215 for bidirectionally communicating data therewith. The microprocessor 215 is coupled to the memory 216 to read instructions for execution and to read and write data therewith. Software code may be stored in the memory 216 or other storage device of the wireless mobile radio unit 104 for execution by the microprocessor 215. As will be discussed further below, the software code may be used to support the various types of wireless communication modes and systems.

Referring now to FIG. 2B, a block diagram of a wireless stationary radio unit 102, such as a cellular telephone base station, is illustrated. The base station 102 supports multicode, multislot, multimode, multiband, multisystem, and/or differing types of wireless communication modes. Base station 102 may be utilized to support the multimode cellular communication system described previously with respect to FIG. 1.

In base station 102, a radio frequency transmitter/receiver or transceiver 226 is provided coupled to the antenna 221. The radio frequency transceiver 226 is a unified hardware component that can support multiple types of wireless communication systems and the multibands, multislots, multicodes, and multimodes, such as CDMA, GSM, TDMA, etc. The radio frequency transceiver 226 couples to a microprocessor 235 of a computer 228 for bidirectionally communicating data therewith.

The computer 228 includes the microprocessor 235 and a memory 236. Software code may be stored in the memory 236 or other storage device (e.g., hard disk) of the computer for execution by the microprocessor 235. As will be discussed further below, the software code may be used to support the various types of wireless communication modes and systems.

The computer 228 and microprocessor 235 therein may externally couple to a communication network or computer network depending upon the type of system where it is utilized. The communication network may be a cellular telephone communication system with a connection to the plain old telephone system (POTS). The computer network may be a wireless local area network for example with a connection to the Internet.

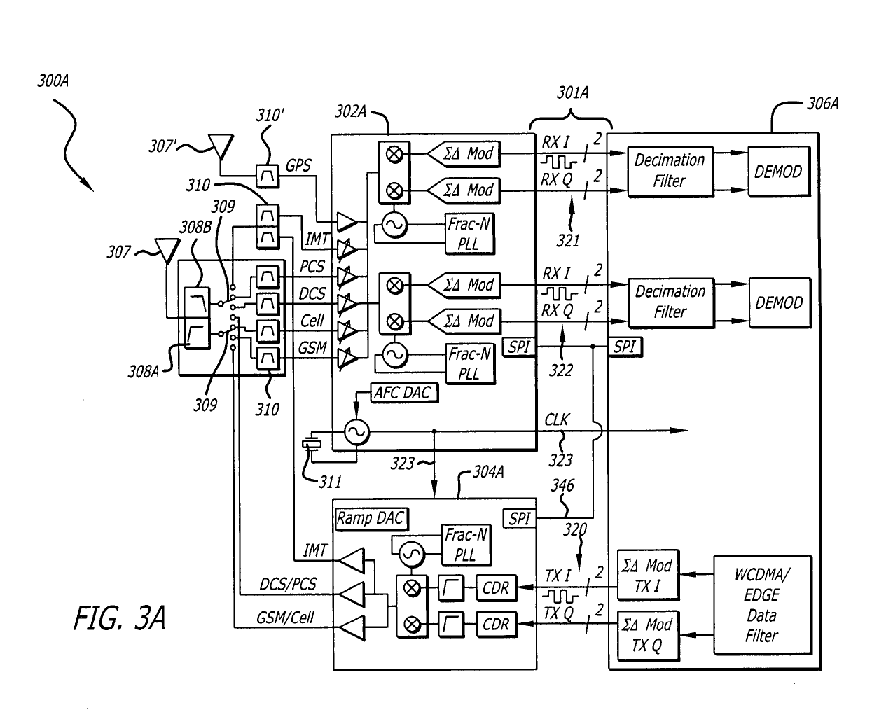

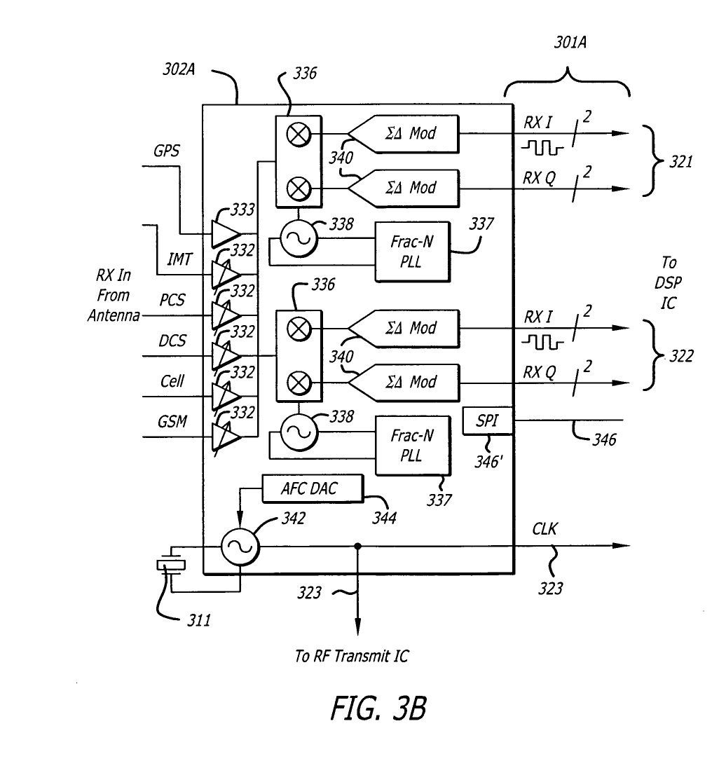

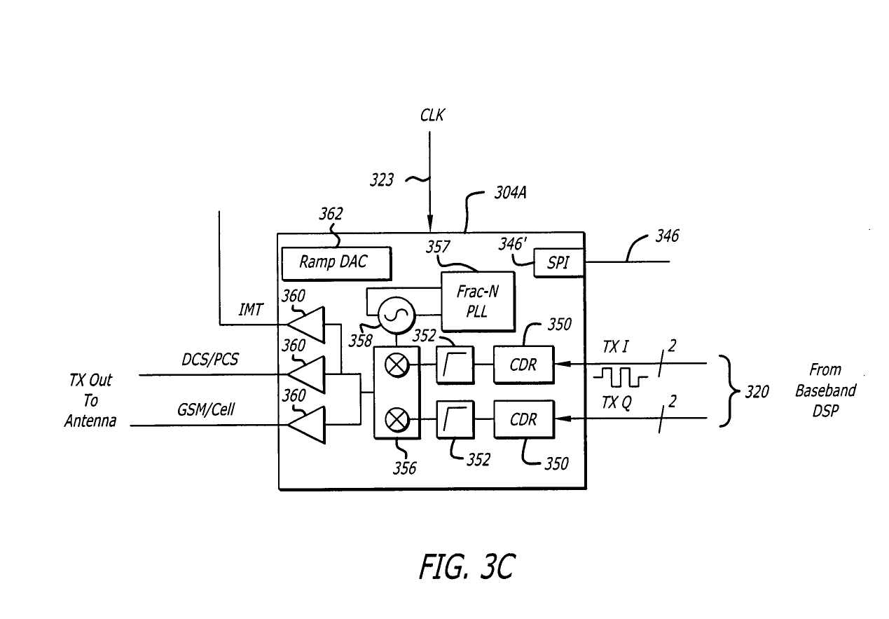

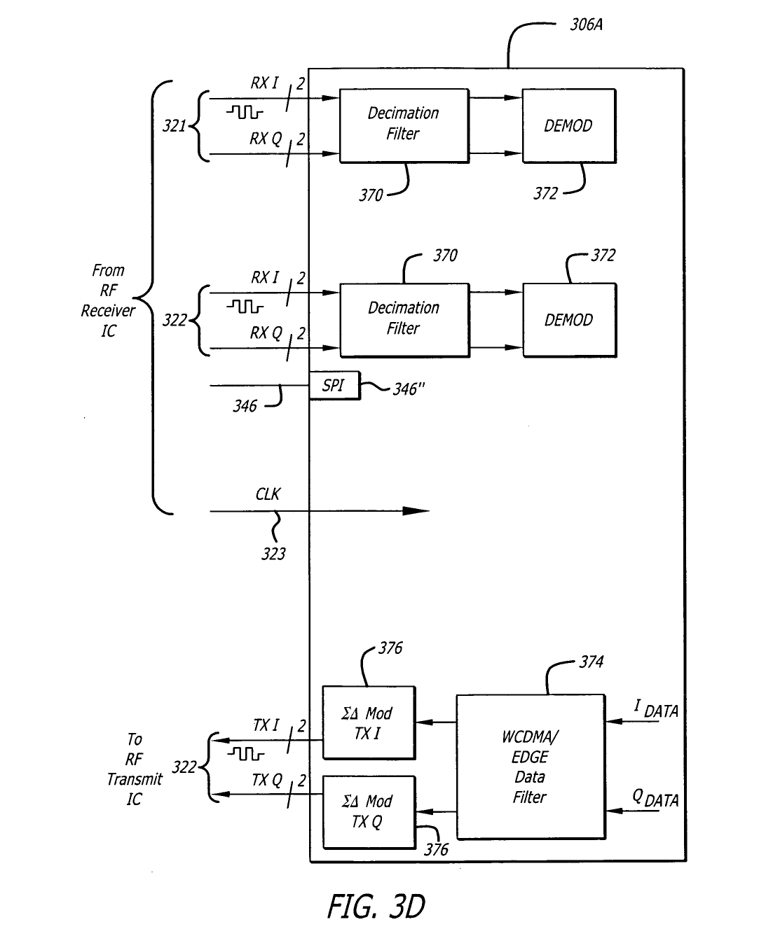

FIGS. 3A, 4, 5, 6A, 7, and 8 illustrate alternate embodiments for the radio frequency transceiver 206 of the wireless mobile radio unit 104 and the radio frequency transceiver 226 of the base station 102 coupled to the antenna.

Referring momentarily now to FIGS. 3A and 4-5, separate receiver radio chips, transmitter radio chips are illustrated coupled to a baseband digital signal processing chip. With greater integration and lower power, the separate receiver radio chips and transmitter radio chips may be integrated together into a transceiver radio chip. Additionally, the baseband digital signal processing chip may be one or more digital signal processor integrated circuits or a programmable general purpose processor, such as a microprocessor, with program instructions to provide digital signal processing.

Referring now to FIG. 3A, an embodiment of the invention is illustrated. FIG. 3A illustrates a system 300A including a radio receiver integrated circuit (IC) 302A, a radio transmitter IC 304A, and a baseband digital signal processing (DSP) IC 306A coupled together as shown to support multiple wireless communication system, sometimes referred to as multimode.

The system 300A further includes a duplex antenna 307, a GPS receiving antenna 307′, a low pass receive passive filter 308B coupled between the antenna 307 and a duplexer switch 309, a high pass transmit passive filter 308A coupled between the antenna 307 and the duplexer switch 309, a GPS band-pass passive filter 310′ coupled between the antenna 307′ and a low noise amplifier of the radio receiver IC 302A, a plurality of band-pass passive filters 310 coupled between the duplexer switch 309 and one or more programmable gain low noise amplifiers of the radio receiver IC 302A, one band-pass passive filter 310 coupled between the duplexer switch 309 and a power amplifier of the radio transmit IC 304A, and the duplexer switch 309 coupled between the filter 308A,308B at one pole and filters 310 and power amplifiers at another pole, as illustrated and coupled together as shown in FIG. 3A.

The system 300A may further include a quartz crystal 311 coupled to a clock generator of the radio receiver IC 302A. A reference clock signal, Clock 323, generated by the clock generator may be coupled from the radio receiver IC 302A into the baseband DSP IC 306A and the radio transmitter IC 304A. The reference clock signal is a reference clock that is used to generate high speed local clock signals within the baseband DSP IC 306A and the radio transmitter IC 304A. The reference clock signal may be varied for the system to adapt to various wireless communication systems with different carrier frequencies and various data communication rates. The reference clock signal, Clock 323, is a lower level frequency than that of the internal local clocks within the baseband DSP IC 306A and the radio transmitter IC 304A in order to reduce noise generated by an external or off-chip clock signal.

A serial control bus 324 may also couple from the baseband DSP IC 306A into the radio receiver IC 302A and the radio transmitter IC 304A to control the selection frequencies and tailor the RF integrated circuits for the wireless communication channels of the selected wireless communication systems.

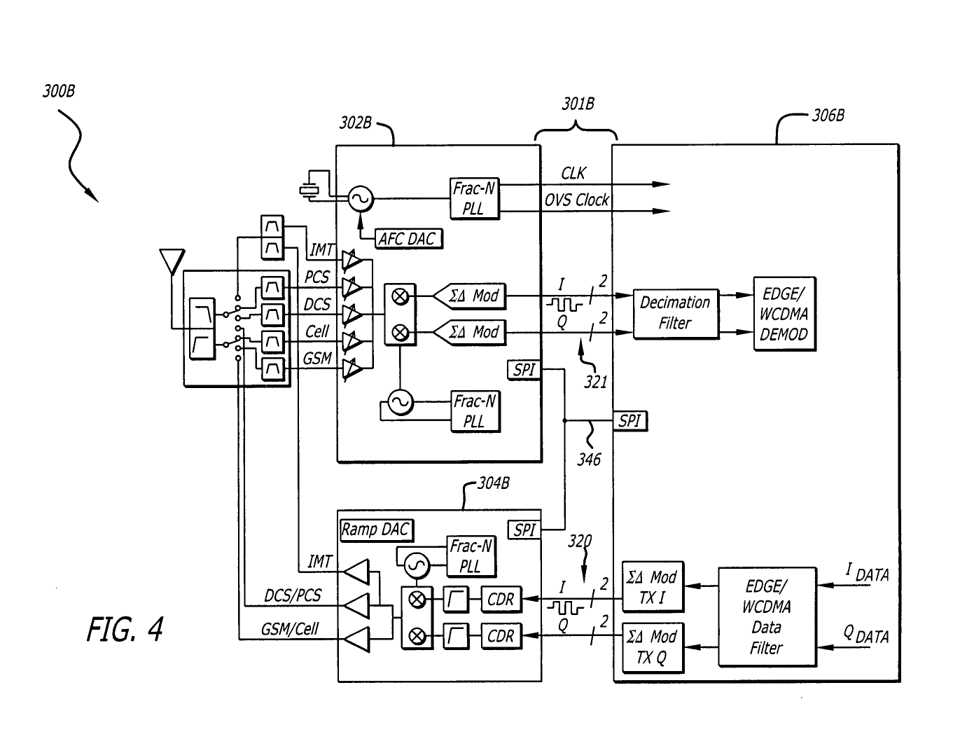

The embodiments of the systems illustrated in FIGS. 4-6A, and 7-8 may have similar passive filters 308A,308B,310,310′; duplexer switches 309; and one or more antennas 307,307′ coupled together with slight variations to support chosen wireless communication systems. As these details are not pertinent to the invention, they are not described in further detail below, but are illustrated in the Figures.

The system 300A illustrated in FIG. 3A can support five wireless communication systems (i.e., pentaband) including Universal Mobile Telecommunication System (UMTS), Global System for Multiple Communication (GSM), General Packet Radio Protocol System (GPRS), Enhanced Data GSM Environment (EDGE), and Global Positioning System (GPS) wireless communication systems. An alternate embodiment from that illustrated in FIG. 3 eliminates the GPS receiver. In another alternate embodiment, GSM, GPRS, and EDGE are not supported as one of the communication systems of the multimode communication systems and thus, the extra circuitry and connections to support GSM, GPRS, and EDGE are not required.

The radio receiver integrated circuit (IC) 302A receives analog radio frequency signals, performs analog signal processing, and converts them into one or more serial digital bit streams in a low voltage differential signal format to be coupled into the baseband DSP IC 306A.

The baseband digital signal processing (DSP) IC 306A digitally processes the one or more serial digital bit streams in the low voltage differential signal format and performs digital filtering to extract the received digital data from the wireless communication link. For transmission, the baseband digital signal processing (DSP) IC 306A accepts digital data that is to be transmitted and pre-distorts the transmit digital data using digital filtering, responsive to what communication link the data is being transmitted, and generates one or more serial digital bit streams in the low voltage differential signal format for communication to the radio transmitter IC 304A.

The radio transmitter IC 304A receives the one or more serial digital bit streams in the low voltage differential signal format representing the data that is to be transmitted. The radio transmitter IC 304A converts the one or more serial digital bit streams in the low voltage differential signal format into analog signals, performs analog signal processing, and amplifies the analog signals for transmission and broadcast out over the antenna.

The interface between radio integrated circuits (e.g., the radio receiver IC 302A and the radio transmitter IC 304A) and the baseband digital signal processing (DSP) IC in the invention is a digital interface. Typical mixed signal circuitry employed between radio ICs and the baseband DSP IC has been eliminated by the invention. Typically a mixed signal codec IC was employed as the mixed signal interface or mixed signal codec circuitry was placed on the DSP IC. A new digital interface, one aspect of the invention, is employed between the radio ICs and the baseband DSP IC to eliminate the mixed signal interface. The invention reduces system cost by eliminating the mixed signal interface. Analog circuitry is not needed between or on the baseband DSP IC. Without analog circuitry on the baseband DSP IC, faster migration of the baseband DSP IC to circuits with smaller process manufacturing technologies can be had further reducing costs of the baseband DSP IC. Moreover, the digital interface may use a low voltage differential swing to support high-speed data transfer between the radio frequency ICs and the baseband DSP IC.

As one aspect of the invention, the system 300A includes a digital interface 301A between the radio integrated circuits (e.g., the radio receiver IC 302A and the radio transmitter IC 304A) and the baseband digital signal processing (DSP) IC 306A. The digital interface 301A in the system 300A of FIG. 3A is one or more receive channels 321-322 and one or more transmit channels 320. Each channel is a digital serial bit stream. A parallel digital word is not employed in order to reduce a large number of I/O traces that otherwise would be needed. The digital serial bit interface reduces the noise that would otherwise be generated by parallel data bus traces that may otherwise interfere with radio frequency signals. A digital serial bit interface further eliminates any noise sensitive analog traces that otherwise might have been used between radio ICs and the baseband DSP IC.

Each channel may communicate using a low voltage swing differential signal, in which case two wire traces are used for each. The one or more receive channels 321 and 322 each include an RX I channel and an RX Q channel for complex data including imaginary and real terms. In an alternate embodiment, the RX I channel and a RX Q channel may be interleaved into one RX channel. The one or more transmit channels 320 include a TX I channel and a TX Q channel for complex data signals including imaginary and real terms (e.g., S=Q+Ij). In an alternate embodiment, the TX I channel and a TX Q channel may be interleaved into one TX channel. In yet another embodiment, the RX Q channel and RX I channel are magnitude data and phase data of a multiphase signal S, where S=Qe^{jI}. These are also sometimes referred to as polar coordinates.

Referring now to FIG. 3B, a magnified block diagram of the radio frequency receiver integrated circuit 302A is illustrated. The radio frequency receiver integrated circuit 302A, includes one or more programmable gain low noise amplifiers 332, a constant gain low noise amplifier 333, one or more pairs of mixers 336 also referred to as down converters, one or more programmable phase locked loops (Frac-N PLL) 337, one or more local oscillators 338, one or more pairs of sigma-delta modulators (ΣΔ Mod) 340, a frequency controlled clock generator 342, an automatic frequency control digital to analog converter (AFC DAC) 344, and a serial peripheral interface (SPI) 346 coupled together as shown and illustrated in FIG. 3B.

The one or more programmable gain low noise amplifiers 332 receive the analog radio frequency signals from various wireless communication systems. The constant gain low noise amplifier 333 receives analog radio frequency signals broadcast from GPS satellites.

The one or more pairs of mixers 336 couple to outputs of the amplifiers 332,333 and down convert the analog radio frequency signals into an intermediate or baseband frequency analog signal and generate the in-phase or real (I) component and the quadrature phase or imaginary (Q) component of the analog signal. The one or more programmable phase locked loops (Frac-N PLL) 337 couple to and control the one or more local oscillators 338. The one or more local oscillators 338 selectively generate a carrier frequency signal for a given system that is coupled into the one or more pairs of mixers 336. It is this carrier frequency signal that is used to strip away the carrier frequency from the analog radio frequency signals.

The one or more pairs of sigma-delta modulators (ΣΔ Mod) 340 are coupled respectively to the I and Q component outputs of the one or more pairs of mixers 336 to receive the analog I and Q signals. The one or more pairs of sigma-delta modulators (ΣΔ Mod) 340 quantize and convert the I and Q analog signals into I and Q serial digital bit signals.

In another embodiment, the sigma-delta modulators may be delta modulators. In yet another embodiment, the sigma-delta modulators may be modulating analog-to-digital converters with a single digital bit output to provide a serial bit stream (e.g., an analog-to-digital converter combined with a modulator having a single bit output). In any case, the modulators are a type of modulator that receive an analog input signal and have a single bit output to provide a serial digital data stream. Collectively, the various types of modulators may be referred to herein as single bit modulators or modulating analog-to-digital converters with a single bit output.

The I and Q serial digital bit signals are then coupled into a pair of low differential voltage output drivers (not shown in FIG. 3B) to generate a differential signal with a low voltage swing to speed data transfer external to the chip and lower noise generation.

The automatic frequency control digital to analog converter (AFC DAC) 344 is coupled to and controls the frequency controlled clock generator 342. The external quartz crystal 311 couples into the oscillator inputs of the frequency controlled clock generator 342. The clock output of the frequency controlled clock generator 342 may be coupled to the one or more pairs of sigma-delta modulators (ΣΔ Mod) 340 and may also externally couple to the baseband DSP IC 306A.

The serial peripheral interface (SPI) receiver 346′ may be used to communicate control information serially between integrated circuits of the system 300A. In particular, the baseband DSP IC 306A communicates control information, such as the frequencies, modulation/demodulation, and encoding/decoding for the selected communication channels and systems. The (SPI) bus 346 is a serial data bus.

Referring now to FIG. 3C, a magnified block diagram of the radio frequency transmit integrated circuit 304A is illustrated. The radio frequency transmit integrated circuit 304A includes a pair of data recoverers 350 (also referred to as “data recovery circuit or data recovery functional block”, CDR), a pair of low pass analog filters 352, a pair of mixers 356 also referred to as up-converters, one or more power amplifiers 360, a programmable phase locked loop (Frac-N PLL) 357, a local oscillator 358, a Ramp digital to analog converter (Ramp DAC) 362, and a serial peripheral interface (SPI) 346 coupled together as shown and illustrated in FIG. 3C.

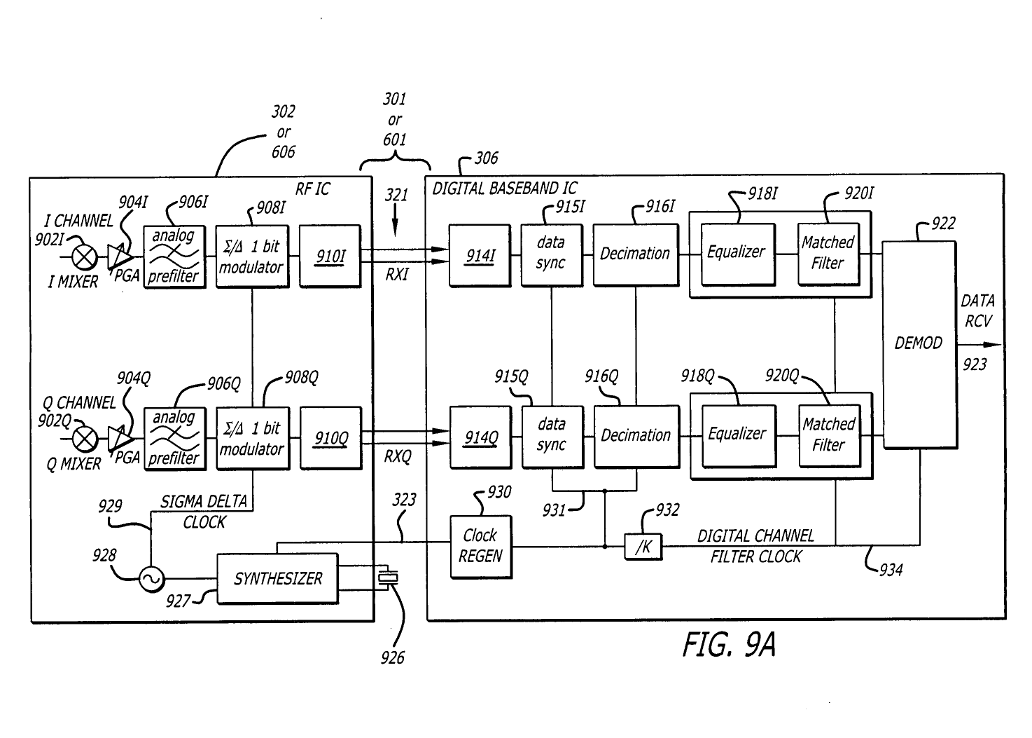

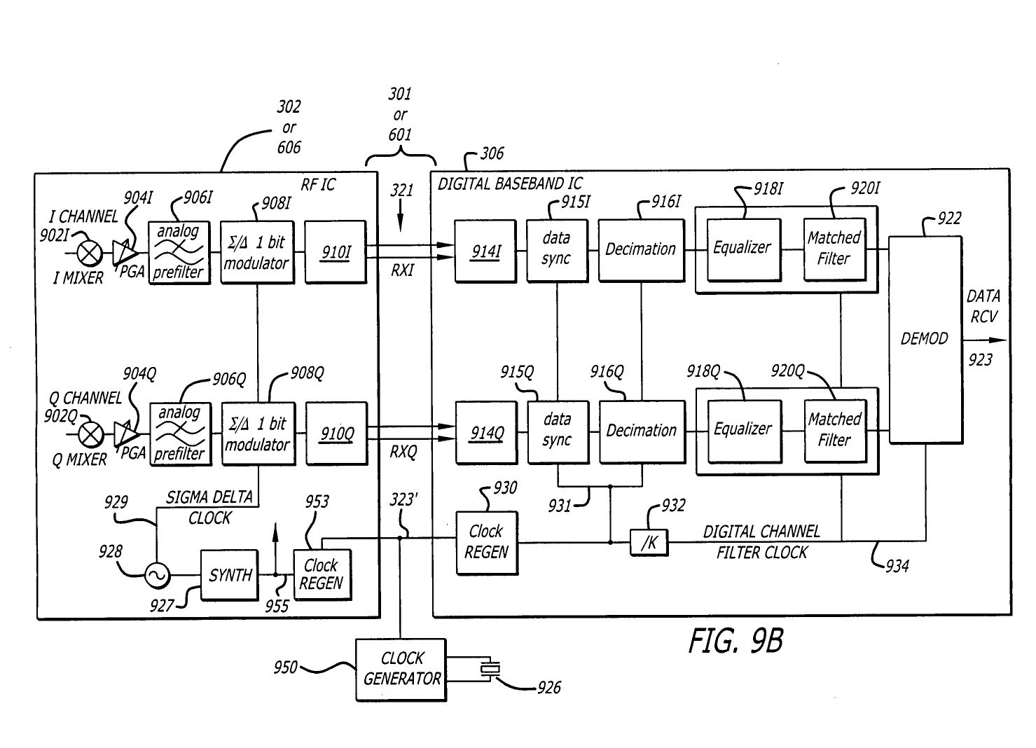

The radio frequency transmit integrated circuit 304A further includes a pair of low voltage differential input receivers (not shown in FIG. 3A, see differential input receivers 914I and 914Q illustrated in FIG. 9A) to receive the low voltage differential digital bit stream of the I and Q channels from the baseband DSP 306A and convert them into a single ended high voltage swing digital bit stream of the I and Q channels on chip.

The pair of data recoverers 350 (also referred to as “data recovery circuit or data recovery functional block”, CDR) receive single ended high voltage swing digital bit stream of the I and Q channels and recover the digital data stream of the I and Q channels. The digital data stream of the I and Q channels are coupled into the pair of low pass analog filters 352 to generate I and Q analog signals for transmission.

The pair of analog filters 352 filter out high frequency noise and generate an analog output signal from the serial bit steam of data. The I and Q analog signals are generated by the low pass filters 352 at a baseband frequency and are coupled into the pair of mixers 356.

The pair of mixers 356 receive the I and Q analog signals at a baseband frequency and up-converter them to the desired carrier frequency for transmission over a given wireless communication system. The carrier frequency is selected by using the programmable phase locked loop (Frac-N PLL) 357 to drive the local oscillator 358. The local oscillator 358, having a selectable carrier frequency, has its oscillation output coupled to one of the inputs of the pair of mixers 356. The pair of mixers 356 combines the I and Q analog signals at the carrier frequencies into a single radio frequency analog signal which is coupled into the one or more power amplifiers 360.

The one or more power amplifiers 360 receive the radio frequency analog signal and amplify it into a radio frequency analog output signal with increased power output that is coupled into the antenna for radiating. The digital interface allowed the one or more power amplifiers 360 to be integrated as part of the transmitter IC 304A because other analog circuitry was eliminated (e.g., the parallel ADC and active analog filters) and power was conserved. The integration of the power amplifier with the transmitter eliminates other circuitry such as isolators and power detectors. The integration of the power amplifier with the transmitter also enables predistortion of transmit signals, in a closed or open loop fashion, and therefore can improve transmitter performance.

The Ramp digital to analog converter (Ramp DAC) 362 is for gently ramping or increasing the power of the one or more power amplifiers 360. It may be used to meet time masking and other special masking requirements.

The serial peripheral interface (SPI) receiver 346′ may be used to communicate control information serially between integrated circuits of the system 300A. In particular, the baseband DSP IC 306A communicates control information, such as the frequencies, modulation/demodulation, and encoding/decoding for the selected communication channels and systems. The (SPI) bus 346 is a serial data bus.

Referring now to FIG. 3D, a magnified block diagram of the baseband DSP integrated circuit 306A is illustrated. The baseband DSP integrated circuit 306A includes one or more pairs of low voltage differential input receivers (not shown), one or more decimators/filters 370, one or more data demodulators 372, a pair of data modulators/filters 374, a pair of sigma-delta modulators (ΣΔ Mod) 376, a pair of low voltage differential output drivers (not shown) and a serial peripheral interface (SPI) transmitter 346″ coupled together as shown and illustrated in FIG. 3D.

The one or more pairs of low voltage differential input receivers (not shown) receive the low voltage differential digital bit stream of the I and Q channels from the RF receiver IC 302A and convert them into a single ended high voltage swing digital bit stream of the I and Q channels on chip. There may be one or more pairs used in order to simultaneously support communication over more than one wireless communication system. That is, two channels of communication may be supported. For example, GPS data signals may be received over one communication system such as for navigation or positioning while CDMA voice signals may be simultaneously received over another communication system for wireless cellular telephone calls.

The one or more decimators/filters 370 lower the sampling rate of the I and Q serial bit stream, provide digital filtering, detect data from noise, and convert serial bits into parallel words to generate and received I and Q data words. The function of the one or more decimators/filters 370 is further described below with reference to FIG. 9A.

The one or more data demodulators 372 receives the I and Q data, demodulates the channel modulation, performs further filtering, and converts serial data into parallel data in order to form the received digital data from the wireless communication system. The one or more data demodulators 372 are programmable based on the selected wireless communication system over which data is being received. The function of the one or more data demodulators 372 is further described below with reference to FIG. 9A.

In order to transmit, transmit data is coupled into the pair of data modulators/filters 374. The pair of data modulators/filters 374 provide channel modulation, generating the I and Q components from the transmit data, and digitally prefilter or distort the I and Q digital data components for transmission over the wireless communication system. Depending upon the wireless communication system over which data is being transmitted, the digital data modulator/filter is programmable to select the wireless communication system. The digital data for the I and Q channels is coupled into the pair of sigma-delta modulators (ΣΔ Mod) 376.

The pair of sigma-delta modulators (ΣΔ Mod) 376 are coupled respectively to the I and Q component outputs from the pair of data modulators/filters 374. The pair of sigma-delta modulators (ρΔ Mod) 376 quantize and convert the I and Q parallel digital signals into I and Q serial digital bit signals. The clock 323 received from the RF receiver IC 302A may be used to clock the one or more pairs of sigma-delta modulators (ΣΔ Mod) 376 to generate the I and Q serial digital bit signals. The I and Q serial digital bit signals are then coupled into the pair of low differential voltage output drivers (not shown).

The pair of low differential voltage output drivers generates a differential signal for each of the I and Q serial digital bit streams with a low voltage swing to speed data transfer external to the chip and lower noise generation. The I and Q serial digital bit streams in a low differential voltage output format is coupled into the RF transmit IC 304A.

Referring now to FIG. 4, another embodiment of the invention is illustrated. FIG. 4 illustrates a system 300B including a radio receiver integrated circuit (IC) 302B, a radio transmitter IC 304B, and a baseband digital signal processing (DSP) IC 306B coupled together as shown to support multiple wireless communication system, sometimes referred to as multimode. FIG. 4 also supports five systems (i.e., pentaband) including a UMTS compressed mode and an EDGE compressed mode system. As described previously with respect to FIG. 3, alternative embodiments may be achieved from that illustrated in FIG. 4 by reducing the number and type of wireless communications systems supported so that combinations of single, dual, triple, and quad bands may be supported instead of the pentaband wireless communications systems illustrated.

As one aspect of the invention, the system 300B includes a digital interface 301B between the radio integrated circuits (e.g., the radio receiver IC 302B and the radio transmitter IC 304B) and the baseband digital signal processing (DSP) IC 306B. The digital interface 301B in the system 300B of FIG. 4 is one or more receive channels 321 and one or more transmit channels 320. Each channel is a digital serial bit stream. Each channel may communicate using a low voltage swing differential signal, in which case two wire traces are used for each. The one or more receive channels 321 include a RX I channel and a RX Q channel for complex data including imaginary and real terms. In an alternate embodiment, the RX I channel and a RX Q channel may be interleaved into one RX channel. The one or more transmit channels 320 include a TX I channel and a TX Q channel for complex data including imaginary and real terms. In an alternate embodiment, the TX I channel and a TX Q channel may be interleaved into one TX channel.

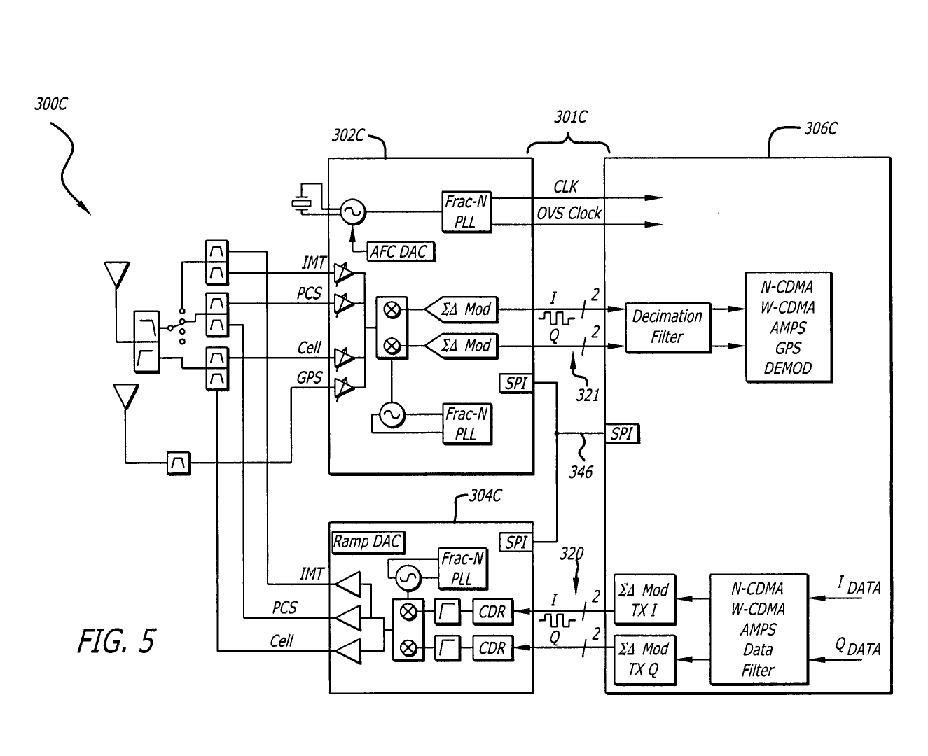

Referring now to FIG. 5, another embodiment of the invention is illustrated. FIG. 5 illustrates a radio receiver integrated circuit (IC) 302C, a radio transmitter IC 304C, and a baseband digital signal processing (DSP) IC 306C coupled together as shown to support multiple wireless communication system, sometimes referred to as multimode. The embodiment of FIG. 5 supports four systems (i.e., quadband) including PCS with an N-CDMA code-division-multiple access wireless communication system. The embodiment of FIG. 5 further supports an IMT with a W-CDMA, AMPS cellular, and GPS. As described previously with respect to FIG. 3, alternative embodiments may be achieved from that illustrated in FIG. 5 by reducing the number and type of wireless communications systems supported so that combinations of single, dual, and triple bands may be supported instead of the quadband wireless communications systems illustrated. That is, the system of FIG. 5 may or may not include support for GPS and W-CDMA functionality.

As one aspect of the invention, the system 300C includes a digital interface 301C between the radio integrated circuits (e.g., the radio receiver IC 302C and the radio transmitter IC 304C) and the baseband digital signal processing (DSP) IC 306C. The digital interface 301C in the system 300C of FIG. F is one or more receive channels 321 and one or more transmit channels 320. Each channel is a digital serial bit stream. Each channel may communicate using a low voltage swing differential signal, in which case two wire traces are used for each. The one or more receive channels 321 include a RX I channel and a RX Q channel for complex data including imaginary and real terms. In an alternate embodiment, the RX I channel and a RX Q channel may be interleaved into one RX channel. The one or more transmit channels 320 include a TX I channel and a TX Q channel for complex data including imaginary and real terms. In an alternate embodiment, the TX I channel and a TX Q channel may be interleaved into one TX channel.

The baseband digital signal processing (DSP) IC 306C provides support for the four systems (i.e., quadband) illustrated in FIG. 5, including PCS with an N-CDMA code-division-multiple access wireless communication system. The DSP IC 306C includes a demodulator to selectively demodulate signals from N-CDMA, W-CDMA, AMPS, and GPS wireless communication systems. The DSP IC 306C further includes a data filter to selectively filter signals for transmission over N-CDMA, W-CDMA, AMPS, and GPS wireless communication systems. Because the active channel filtering is performed in the DSP 306C using digital filtering techniques, the filter coefficients can be easily modified and the frequency selected for whatever wireless communication system over which communication is desired. The flexibility provided by the invention enables the use of one or two radio chips and one DSP chip to address multiple communications standards by software selection, referred to as “Software Radio”.

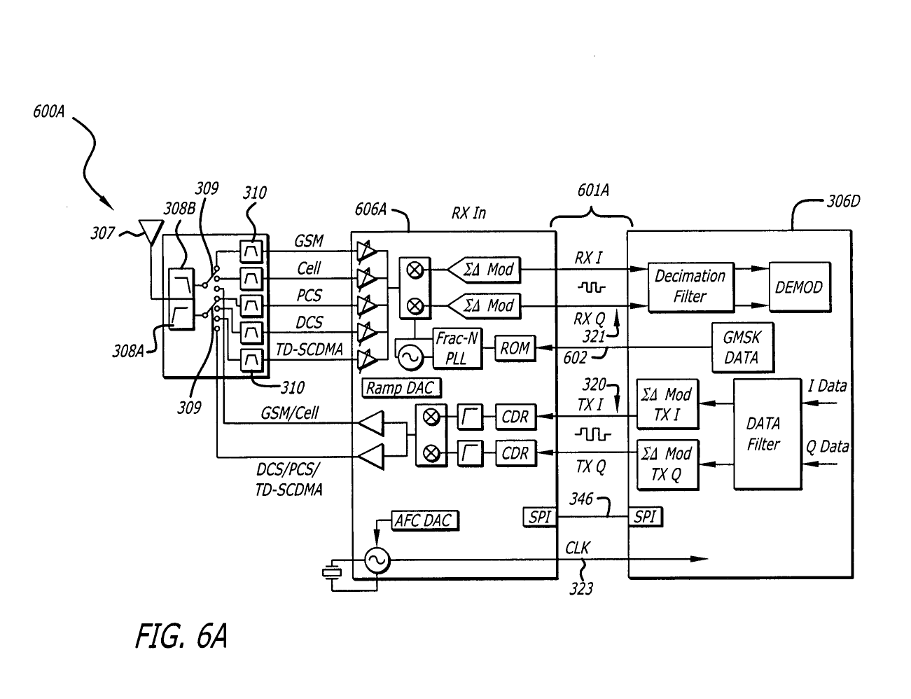

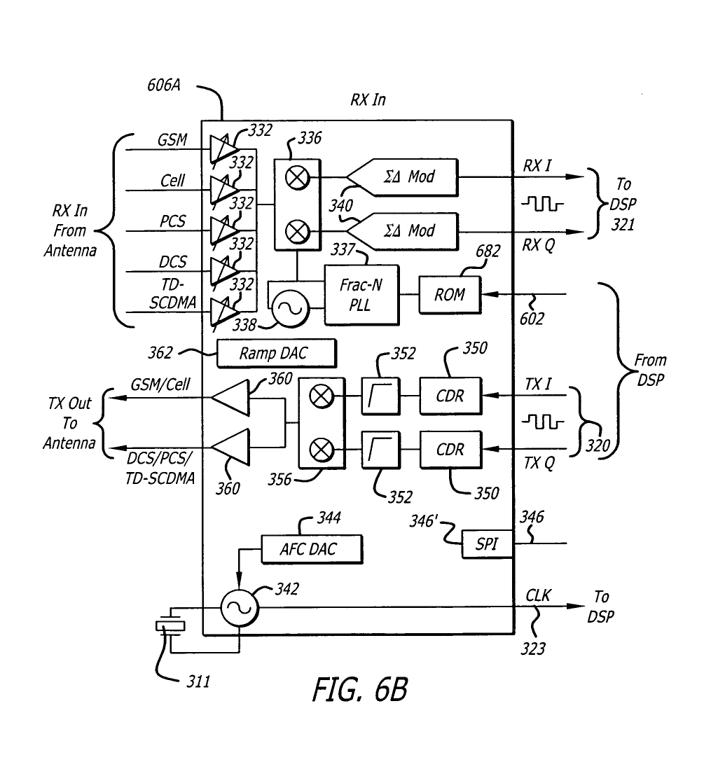

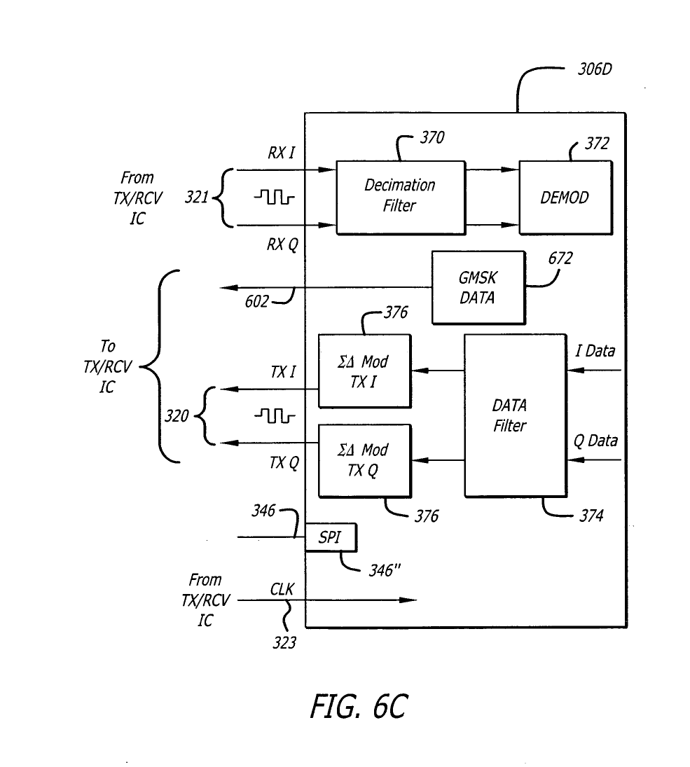

Referring momentarily now to FIGS. 6A and 7-8, integrated transceiver radio chips are illustrated coupled to baseband digital signal processing chips. The integrated transceiver radio chips combine receive and transmit functionality into a single radio frequency integrated circuit.

Referring now to FIG. 6A, another embodiment of the invention is illustrated. FIG. 6A illustrates a system 600A including a radio transceiver integrated circuit (IC) 606A, and a baseband digital signal processing (DSP) IC 306D coupled together as shown to support multiple wireless communication system, sometimes referred to as multimode. The system 600A of FIG. 6A may support up to five wireless communication systems (i.e., pentaband) including a TD-SCDMA system. The system 600A may also be used to support multiple bands of TD-SCDMA systems. Additionally, the system 600A may also be used to support GSM/GPRS/EDGE, AMPS, PCS, and DCS wireless communication systems. In an alternative embodiment, 3GPP TDD may replace TD-SCDMA. Alternative embodiments may also be achieved from that illustrated in FIG. 6A by reducing the number and type of wireless communications systems supported so that combinations of single, dual, triple, and quad bands may be supported instead of the pentaband wireless communications systems illustrated.

As one aspect of the invention, the system 600A includes a digital interface 601A between the radio integrated circuit (e.g., the radio transceiver IC 606A) and the baseband digital signal processing (DSP) IC 306D. The digital interface 601A in the system 600A of FIG. 6A is one or more receive channels 321 and one or more transmit channels 320. Each channel is a digital serial bit stream. Each channel may communicate using a low voltage swing differential signal, in which case two wire traces are used for each. The one or more receive channels 321 include a RX I channel and a RX Q channel for complex data including imaginary and real terms. In an alternate embodiment, the RX I channel and a RX Q channel may be interleaved into one RX channel. The one or more transmit channels 320 include a TX I channel and a TX Q channel for complex data including imaginary and real terms. In an alternate embodiment, the TX I channel and a TX Q channel may be interleaved into one TX channel.

Referring now to FIG. 6B, a block diagram of the radio transceiver integrated circuit 606A is illustrated. The radio transceiver integrated circuits 606B and 606C briefly described below are subsets of the radio transceiver integrated circuit 606A. That is, the radio transceiver integrated circuits 606B and 606C have fewer circuit elements than that of the radio transceiver integrated circuit 606A.

The radio transceiver integrated circuit 606A combines elements of the previously described radio receiver integrated circuit 302A and the radio transmitter integrated circuit 304A into one integrated circuit. An extra receive channel of communication is not used, as GPS signals are not directly received by the radio over a wireless communication link in this case. As elements with the same reference numbers have similar functionality in the radio transceiver integrated circuit 606A and is described previously, the detailed description of the functional blocks is not repeated here for brevity.

The radio frequency transceiver integrated circuit 606A, includes one or more programmable gain low noise amplifiers 332, a pairs of mixers 336 also referred to as down converters, a pair of low voltage differential output drivers (not shown), a programmable phase locked loop (Frac-N PLL) 337, a local oscillator 338, a pair of sigma-delta modulators (ΣΔ Mod) 340, a frequency controlled clock generator 342, an automatic frequency control digital to analog converter (AFC DAC) 344, a serial peripheral interface (SPI) 346, a pair of low voltage differential input receivers (not shown), a data recoverer 350 (also referred to as a data recovery circuit or functional blocks), a pair of low pass analog filters 352, a pair of mixers 356 also referred to as up-converters, one or more power amplifiers 360, a Ramp digital to analog converter (Ramp DAC) 362, and a read only memory (ROM) 682 coupled together as shown and illustrated in FIG. 6B.

The read only memory (ROM) 682 is for constant envelope wireless communication systems (frequency modulation without amplitude modulation) with low data rates, particularly GMSK data modulation. The ROM 682 is a look up table and acts as a waveform generator. Data bits are coupled into the ROM 682 to change the frequency of the constant envelope signal. The ROM 682 couples to a GMSK data modulator of the baseband DSP integrated circuits 306D to receive a data signal. The output of the ROM 682 is coupled to the PLL 337 in order to control the selection of the carrier frequency generated by the local oscillator 338.

Otherwise, the elements with the same reference numbers have similar functionality in the baseband DSP IC 306A and are described previously, the detailed description of the functional blocks is not repeated here for brevity.

Referring now to FIG. 6C, a block diagram of the baseband DSP integrated circuit 306D is illustrated. The baseband DSP integrated circuit 306D is similar to the baseband DSP integrated circuit 306A-306C previously described. The baseband DSP integrated circuits 306E and 306F briefly described below are subsets of the baseband DSP integrated circuit 306D. That is, the baseband DSP integrated circuits 306E and 306F have less functionality than that of the functionality of the baseband DSP integrated circuit 306D. But for the hardware changes for receiving and/or transmitting an extra channel of data over the digital interface, the digital filtering, encoding, decoding, modulation and demodulation of digital data preformed by the baseband DSP integrated circuit may be software programmable from circuit to circuit.

The baseband DSP integrated circuit 306D includes a pair of low voltage differential input receivers (not shown), a decimator/filter 370, a data demodulator 372, a data modulator/filter 374, a pair of sigma-delta modulators (ΣΔ Mod) 376, a pair of low voltage differential output drivers (not shown), a serial peripheral interface (SPI) 346, and a GMSK data modulator 672 coupled together as shown and illustrated in FIG. 6C.

The GMSK data modulator 672 is not illustrated in FIG. 3D as being a part of the baseband DSP IC 306A. The GMSK data modulator 672 of the baseband DSP integrated circuit 306D generates a data signal. The output of the GMSK data modulator 672 is coupled into the input of a ROM 682 in order to control the selection of the carrier frequency generated by the local oscillator 338 within the radio transceiver IC 606A.

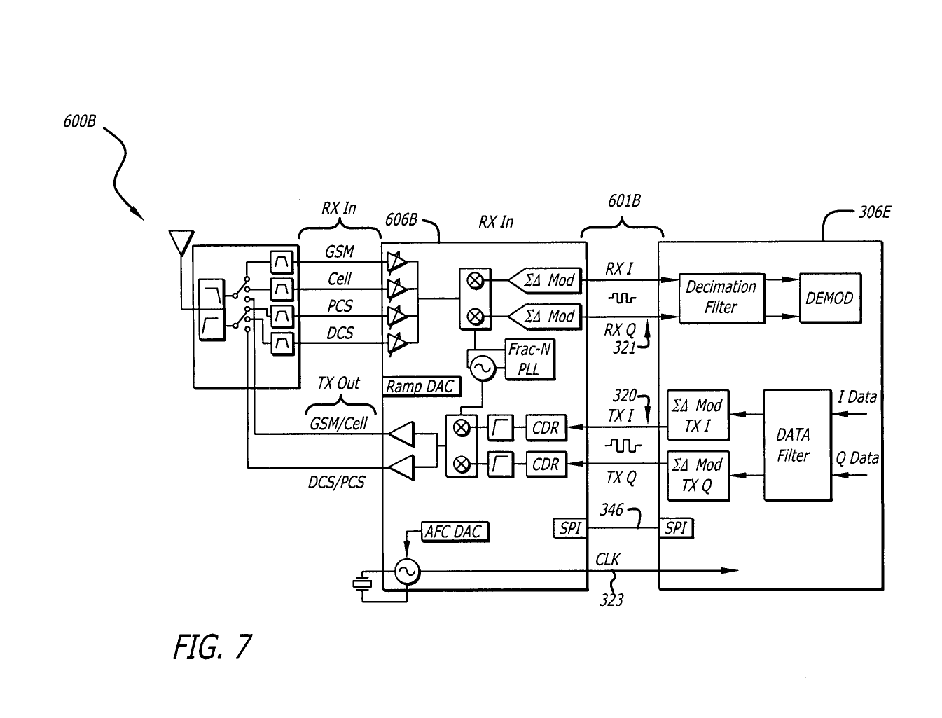

Referring now to FIG. 7, another embodiment of the invention is illustrated. FIG. 7 illustrates a system 600B including a radio transceiver integrated circuit (IC) 606B, and a baseband digital signal processing (DSP) IC 306E coupled together as shown to support multiple wireless communication system, sometimes referred to as multimode. The system 600B of FIG. 7 may support four wireless communication systems (i.e., quadband) including an EDGE or GAIT system. The system 600B may also be used to support AMPS, PCS, and DCS wireless communication systems. Alternative embodiments may be achieved from that illustrated in FIG. 7 by reducing the number and type of wireless communications systems supported so that combinations of single, dual, and triple bands may be supported instead of the quad band wireless communications systems illustrated.

As one aspect of the invention, the system 600B includes a digital interface 601B between the radio integrated circuit (e.g., the radio transceiver IC 606B) and the baseband digital signal processing (DSP) IC 306E. The digital interface 601B in the system 600B of FIG. 7 is one or more receive channels 321 and one or more transmit channels 320. Each channel is a digital serial bit stream. Each channel may communicate using a low voltage swing differential signal, in which case two wire traces are used for each. The one or more receive channels 321 include a RX I channel and a RX Q channel for complex data including imaginary and real terms. In an alternate embodiment, the RX I channel and a RX Q channel may be interleaved into one RX channel. The one or more transmit channels 320 include a TX I channel and a TX Q channel for complex data including imaginary and real terms. In an alternate embodiment, the TX I channel and a TX Q channel may be interleaved into one TX channel.

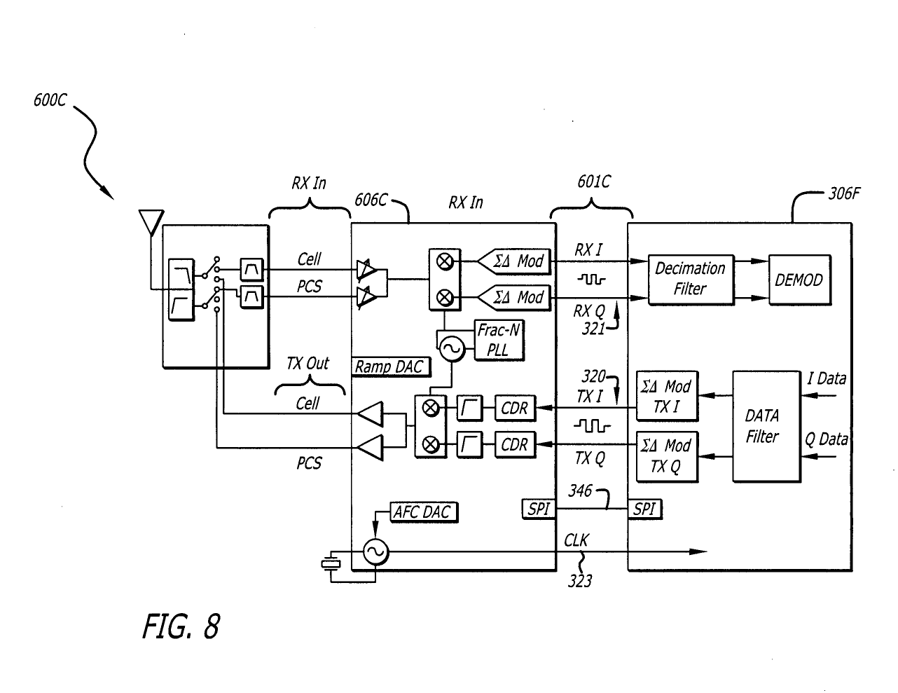

Referring now to FIG. 8, another embodiment of the invention is illustrated. FIG. 8 illustrates a system 600C including a radio transceiver integrated circuit (IC) 606C, and a baseband digital signal processing (DSP) IC 306F coupled together as shown to support multiple wireless communication system, sometimes referred to as multimode. The system 600C of FIG. 8 may support two wireless communication systems (i.e., dualband) including TDMA (i.e., PCS) and AMPS wireless communication systems. An alternative embodiment may be achieved from that illustrated in FIG. 8 by eliminating the AMPS system so that only a TDMA (i.e., PCS) wireless communication system is supported as a single band system.

As one aspect of the invention, the system 600C includes a digital interface 601C between the radio integrated circuit (e.g., the radio transceiver IC 606C) and the baseband digital signal processing (DSP) IC 306F. The digital interface 601C in the system 600C of FIG. 8 is one or more receive channels 321 and one or more transmit channels 320. Each channel is a digital serial bit stream. Each channel may communicate using a low voltage swing differential signal, in which case two wire traces are used for each. The one or more receive channels 321 include a RX I channel and a RX Q channel for complex data including imaginary and real terms. In an alternate embodiment, the RX I channel and a RX Q channel may be interleaved into one RX channel. The one or more transmit channels 320 include a TX I channel and a TX Q channel for complex data including imaginary and real terms. In an alternate embodiment, the TX I channel and a TX Q channel may be interleaved into one TX channel.

Referring now to FIG. 9A, a block diagram of the receive channel 321 of the digital interfaces 301A-301D,601A-601D (referred to collectively as interface 301,601) is illustrated in greater detail between the radio frequency integrated circuits 302A-302D,606A-606D (referred to collectively as radio frequency integrated circuit 302,606) and the baseband digital signal processing ICs 306A-306F (referred to collectively as baseband digital signal processing IC 306). The in-phase or real component (I) receive channel and the quadrature or imaginary component (Q) receive channel of the receive channel 321 are mirror images of one another but carry different data.

In the radio frequency IC 302,606, the I receive channel includes a mixer or down-converter 902I, a programmable gain amplifier (PGA) 904I, an analog prefilter 906I, a sigma-delta modulator 908I, and a low voltage differential output driver 910I coupled in series together. The low voltage differential output driver 910I couples to a pair of wire traces between the radio frequency integrated circuit 302,606 and the baseband digital signal processing IC 306 to carry the differential signal there-between. The Q receive channel in the radio frequency IC 302,606 includes a mixer or down-converter 902Q, a programmable gain amplifier (PGA) 904Q, an analog prefilter 906Q, a sigma-delta modulator 908Q, and a low voltage differential output driver 910Q coupled in series together. The low voltage differential output driver 910Q couples to a pair of wire traces between the radio frequency integrated circuit 302,606 and the baseband digital signal processing IC 306 to carry the differential signal there-between.

The radio frequency IC 302,606, further includes a clock synthesizer 927 to couple to an external quartz crystal 926, and a local oscillator 928 coupled to the clock synthesizer 927 to generate a sigma-delta clock 929 for the sigma-delta modulators 908I,908Q.

In the baseband DSP IC 306, the I receive channel includes a low voltage differential input receiver 914I, a data synchronizer 915I, a decimator 916I, an equalizer 918I, and a matched filter 920I coupled in series together. The Q receive channel in the baseband DSP IC 306 includes a low voltage differential input receiver 914Q, a data synchronizer 915Q, a decimator 916Q, an equalizer 918Q, and a matched filter 920Q coupled in series together.

The baseband DSP IC 306 further includes a clock regenerator 930 to generate a local clock signal 931 from the reference clock signal 323, a clock divider 932 to divide the frequency of the local clock signal 931 by K down to a frequency of a digital channel filter clock 934, and a demodulator 922 to couple to the matched filters 920I,920Q. The demodulator 922 receives data from both the I and Q receive channels to form a received digital data signal (DATA RCV) 923.

In the RF IC 302,606, the mixers 902I,902Q are used to down convert the received I and Q analog data signals from the carrier frequencies of the respective communication system channel into baseband signals. That is, the mixers strip away the carrier frequency from the I and Q analog signals. In other words, the mixers extract the analog data signals at baseband frequency from the received analog signals at the carrier frequencies. The programmable gain amplifiers 904I,904Q, are used to adjust the gain and effectively compress the dynamic range in front of the sigma-delta data modulators 908I,908Q.

Limited passive analog filtering is employed within the RF ICs. Channel filtering is realized entirely in the digital domain by digital filters in the baseband DSP IC. The design is optimized such that the filtering performed in the digital domain by digital filters in the baseband DSP IC removes the undesired signals and with no extra effort. The digital filters in the baseband DSP IC also filter out the inherent quantization noise added to the signal by the single bit modulation performed by the sigma-delta modulators 908I,908Q.

The analog prefilters 906I,906Q are passive analog filters that protect the sigma-delta data modulators 908I,908Q from high interference signals. The passive analog prefilters 906I,906Q are low-pass filters in the baseband frequency of interest. These passive analog prefilters 906I,906Q filter out the unwanted frequency of signals generated by the down converters 902I,902Q.

The sigma-delta modulators 980I,908Q are over sampling quantizers and essentially convert an analog signal into a serial digital bit stream. In comparison with the baseband signal, the sigma-delta modulators 980I,908Q over sample the analog signal at a rate much greater than the Nyquest rate in response to the frequency of the sigma-delta clock 929. The analog signal is quantized into two levels as a digital signal with a high voltage swing between a pair of high voltage difference logic levels (e.g., ground and VCC or −VCC and +VCC). Over time as more samples of the analog signal are taken by the sigma-delta modulators 980I,908Q, a single ended serial digital bit stream is formed having the high voltage swing.

The frequency of the sigma-delta clock 929 and the sampling rate of the sigma-delta modulators 980I,908Q varies depending upon the type of wireless communication system and its frequency bands. The following table illustrates exemplary Chip rates, exemplary sampling rates, and exemplary data rates of the I and Q components for exemplary wireless communication systems, such as WCDMA, TD-SCDMA, GSM/EDGE, N-CDMA and GPS wireless communication systems:

| | SYSTEM | | | | |
|---|---|---|---|---|---|
| | WCDMA | TD_SCDMA | GSM/EDGE | N-CDMA | GPS |
| CHIP RATE Mc/s | 3.84 | 1.28 | 0.270833/0.8125 | 1.2288 | 1.023 |
| SAMPLING | 153.6 | 51.2 | 26 | 49.152 | 147.312 |
| RATE MHz | | | | | |
| I & Q NRZ | 153.6 | 51.2 | 26 | 49.152 | 147.312 |
| DATA RATE | | | | | |
| Mb/s | | | | | |

For example consider the WCDMA mode of the system to support the WCDMA wireless communication system. The receive signals are over sampled by a one bit fourth order sigma-delta modulator (e.g., modulators 908I,908Q) clocked as high as 153.6 MHz. The digital bit stream out of the modulators 908I,908Q is transported across the interface 301,601. Over the interface 301,601 the data need not be encoded in that the data is single bit NRZ serial data stream. The logic of the sigma-delta modulator 908I,908Q may assure that a bit change occurs in the single bit NRZ serial data stream at least once for every 32 bits. As the digital interface 301,601 is a serial bit stream with no packetizing of data, a data exchange protocol need not be used across the interface to recover the data on each side. Moreover, the digital interface 301,601 may be unidirectional when data is only to be transmitted or received.

The over sampling clock for the modulator/demodulator may be separately generated within the RF IC 302,606 (e.g., sigma delta clock 929) and the baseband DSP IC 306 (e.g., local clock signal 931). In this case, clocks at the bit rates are not explicitly exchanged between the RF IC 302,606 and the baseband DSP IC 306. Instead, a common low reference frequency may be used to internally generate a clock at the bit rates in order to reduce noise. The typical reference frequency is a crystal frequency around 20 MHz, while the data rate over the digital interface 301,601 can be above 200 MHz.

In order to recover data, the receiving side of the interface 301,601 uses a data synchronizer 915I,915Q, such as a delay lock loop (DLL), to retrieve the mid sampling point of the serial I and Q bit streams transferred over the interface.

The I and Q bit streams are transported separately in the typical implementation over the interface between the radio frequency integrated circuits and the baseband DSP integrated circuit. However, in the invention, I and Q may also be interleaved onto the same pair of differential serial signal lines. With respect to polarity, the I component leads the Q component for negative frequency deviations.

The low voltage differential output drivers 910I,910Q receive the single ended serial digital bit stream (I and Q bit streams) from the sigma-delta modulators 908I,908Q having the high voltage swing between the pair of high voltage difference logic levels (e.g., ground and VCC). In response to the single ended digital signal with the high voltage swing between the pair of high voltage difference logic levels, the low voltage differential output drivers 910I,910Q generate a double ended low voltage swing differential signal between a pair of low voltage difference logic levels.

In one embodiment, the low voltage differential output drivers 910I,910Q can generate logic levels and the low voltage differential input receivers 914I,914Q can receive logic levels in accordance with a modified LVDS standard of differential signals. In which case, the electrical characteristics of these modified LVDS signals communicated over the interface 303,601 are:

| PARAMETER | CONDITIONS | MIN | TYP | MAX | UNIT |
|---|---|---|---|---|---|
| Output Common Mode | | 1.125 | 1.2 | 1.275 | V |
| Output Differential | | 0.112 | 0.14 | 0.168 | Vp |
| Swing | | | | | |
| Single Ended Output | High current mode: | 92 | 115 | 138 | Ω |
| Resistance | | | | | |
| Single Ended Output | Lower current mode: | | 230 | | Ω |
| Resistance | | | | | |
| Eye pattern opening | window measured at +/−20% | 4 | 5 | | ns |
| | of max swing | | | | |
| | I Q mode | | | | |
| | window measured at +/−20% | 1 | 1.5 | | ns |
| | of max swing | | | | |
| | interleaved mode | | | | |

The LVDS standard is described in an American National Standards Institute specification titled “Electrical Characteristics of Low Voltage Differential Signaling (LVDS) Interface Circuits” published on Jan. 1, 2001 as ANSI TIA/EIA-644-A.

In comparison with the standard LVDS (low voltage differential signaling) logic levels, the data rates of the digital interface 301,601 are lower, the routing distances of the signals are smaller, and there is no parallel loading involved. The digital interface 301,601 saves supply current by reducing the swing at the transmitter end to 140 mV typically, and by using a higher line impedance of 240 ohms differential.

In the baseband DSP IC 306, the low voltage differential input receivers 914I,914Q receive the low voltage swing differential signal generated by the low voltage differential output drivers' 910I,910Q of the RF IC 302,606. The low voltage differential input receivers 914I,914Q convert the low voltage swing differential signal into a single ended digital data signal having a high voltage swing between a pair of high voltage difference logic levels (e.g., ground and VDD).

The data synchronizers 915I,915Q are delay locked loops (DLL) on the receive side of the interface to align the phase of the local clock signal 931 with a phase of the transitions in the single ended digital data signal to properly sample the single ended digital data signal.

The decimators 916I,916Q are samplers that sample the single ended digital data signal to reduce the sampling rate of the digital data signal by K to match the frequency of the digital channel filter clock 934. The decimators 916I,916Q further filter and convert the serial bit stream into parallel words. The rate of conversion is a function of the sampling reduction factor K. Additionally, as the sampling rate is lowered, the number of bits in the parallel word increase. The serial bit stream to parallel word conversion provided by the decimators 916I,916Q is essentially a digital averaging process of the incoming serial bit stream and not an ordinary serial to parallel conversion.

The receiver filters 906I and 906Q are intentionally distorted in order to improve dynamic range and large signal handling characteristics of the overall system. To optimize the overall system design, passive analog filters (e.g., the analog prefilter 906I,906Q) with a low frequency pole were placed at about half the channel bandwidth (BW) of each wireless communication system. In order to compensate for the low frequency pole at half the channel bandwidth of each wireless communication system, the digital filter in the DSP IC, on top of its functions of decimation and channel filtering, performs equalization for the embedded analog poles. The equalizers 918I,918Q are programmable digital non-linear phase—filters programmed into the baseband DSP IC to equalize such data distortion generated by the analog prefilters and the wireless communication system and to remove intersymbol interference.

The matched filters 920I,920Q are programmable digital filters programmed into the baseband DSP IC that approximate the matched filter specific to each wireless communication system over which data is being communicated. The matched filter theoretically provides all the channel selectivity not provided in prior stages of the system to detect the digital data that is being received over the interface 301,601 and the wireless communication system. The order of the matched filters 920I,920Q is appropriately selected to meet the system specifications when combining the Analog Prefilters 906I,906Q; the equalizers 918I,918Q; and the limited order matched filters 920I,920Q together.

The single bit stream of the digital interface 301,601 enables the system to tolerate small residual bit errors in the bit stream with no loss of data.

In one embodiment, an internal clock generator is used in the radio frequency integrated circuit to generate the clock signal 323 to synchronize the radio frequency integrated circuit and the digital signal processing integrated circuit. In another embodiment, the internal clock generator may be within the digital signal processing integrated circuit to generate the clock signal 323 which would then be coupled to the radio frequency integrated circuit. In yet another embodiment, the clock signal 323 can be generated externally from the radio frequency integrated circuit and the digital signal processing integrated circuit.

Referring now to FIG. 9B, a block diagram of an alternate embodiment of clock generation and synchronization between the radio integrated circuit (IC) and the baseband digital signal processing (DSP) IC is illustrated. A reference clock signal 323′ is generated externally from the radio frequency integrated circuit 302,606 and the digital signal processing integrated circuit 306 by a clock generator 950. A quartz crystal 926 may be coupled to the clock generator 950 to generate an accurate reference clock signal 323′.

The reference clock signal 323′ is coupled into the radio frequency integrated circuit 302,606 and the digital signal processing integrated circuit 306 to synchronize the circuits for the serial digital data flow between each. The baseband DSP IC 306 includes the clock regenerator 930 to generate a local clock signal 931 from the reference clock signal 323′. In this case, the radio frequency IC 302,606 may include a clock regenerator 953 to generate a local clock signal 955 from the reference clock signal 323′. The local clock signal 955 is coupled into the synthesizer 927 and other circuits of the radio frequency integrated circuit 302,606. The local clock signal 931 within the baseband DSP IC 306 is coupled into the data synchronizer 915Q, the decimator 916Q, the clock divider 932, and other circuits therein.

This alternate method of clock generation and synchronization illustrated in FIG. 9B may be applied to the embodiments of the invention previously described, such as those described with reference to FIGS. 3A-8.

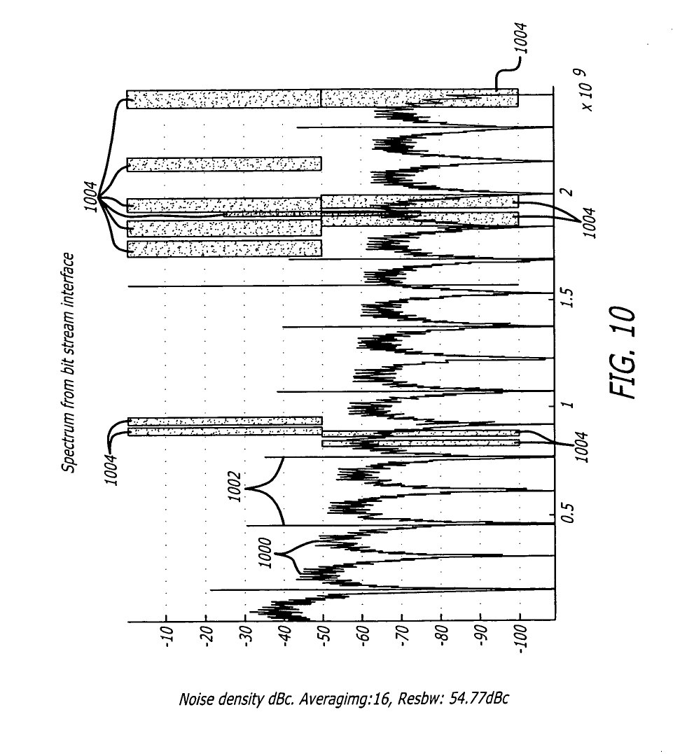

Referring now to FIG. 10, a graph illustrating a simulation of the digital interface is illustrated. The graph of FIG. 10 illustrate interference levels or the noise density provided by the digital serial bit stream of the digital interface in comparison with a 153.6 megaHertz (MHz) clock. The data spectrum is illustrated by the waveform 1000 and has periodic peaks. The periodic peaks in the waveform 1000 are worst case. The clock spectrum illustrated by the waveform 1002 and has periodic peaks. The data spectrum density is much less than the clock noise density. Thus, the digital interface of the invention between the radio frequency IC and the baseband DSP IC has low spurious emission and introduces very little noise into the system. The boxes 1004 overlaid on the spectral densities represent cellular phone frequency bands for wireless communication systems utilized in various countries. The interference spectrum and levels from the high-speed digital interface 301,601 has been simulated and shown to be compatible with the radio specifications of wireless communication systems.

### [Wireless Networking Communication System

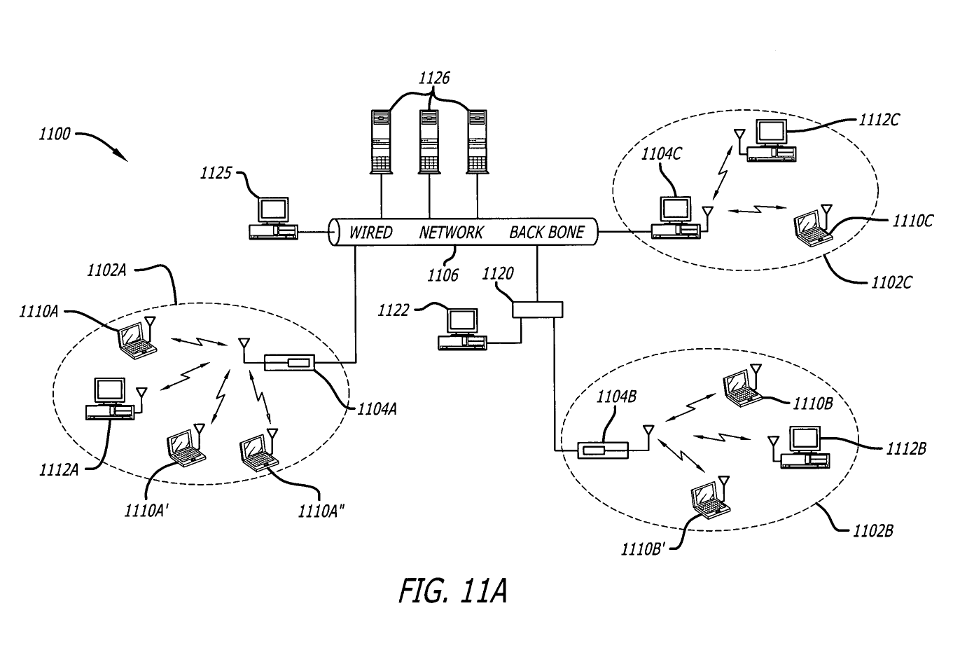

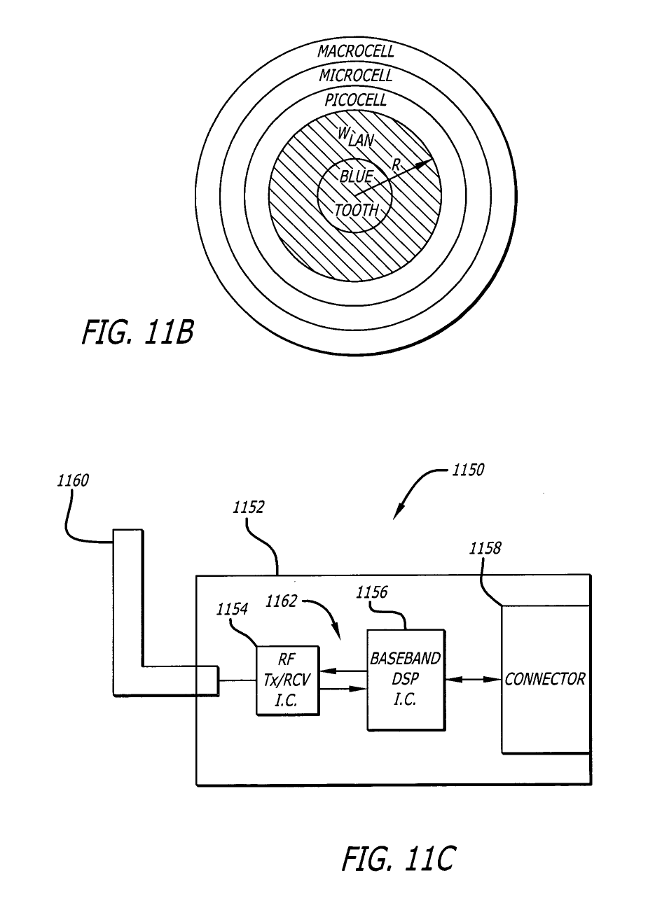

Referring now to FIG. 11A, a wireless network communication system 1100 of mobile and stationary communicating devices is illustrated. The wireless network communication system 1100 may include one or more wireless local area networks (WLANs) 1102A-1102C or other type of wireless networks, such as a wireless metropolitan area network (WMAN), a wireless pan-access network (WPAN), a wireless fidelity (WiFi, IEEE 802.11 wireless networking standard) network, or a worldwide interoperability for microwave access (WiMax, IEEE 802.16 wireless broadband standard) network.

Generally, a wireless local area network (WLAN) is a local area network without wires. Each of the WLANs 1102A-1102C includes a wireless access point (WAP) 1104A-1104C for wireless communication devices to gain access or couple to a wired network backbone 1106 and communicate data or information over it.

Each of the WLANs 1102A-1102C may include mobile wireless communication devices (1110A, 1110A′, 1110A″, 1110B, 1110B′, 1110C) and stationary wireless communication devices (1112A, 1112B, 1112C) to communicate without wires to the wireless access points (WAPs) 1104A-1104C. Each of the WLAN's 1102A-110C may provided handoffs between each other if co-located to each other within a limited geographical area, such as a building. A handoff may occur when a mobile wireless communication device (1110A, 1110A′, 1110A″, 1110B, 1110B′, 1110C) moves from one WLAN to another.

In the preferred embodiment, radio waves are used to communicate wirelessly between mobile wireless communication devices and the wireless access points, such as over a carrier frequency or using a spread spectrum radio. Wireless local area network communication standards have been implemented to which the embodiments of the invention are particularly useful. The Institute of Electrical and Electronic Engineers 802.11a, 802.11b, and 802.11g standards are example wireless local area network communication standards to which the embodiments of the invention are particularly applicable.

The mobile wireless communication devices 1110A, 1110A′, and 110A″ and the stationary wireless communication device 1112A communicate wirelessly with the access point 1104A. The mobile wireless communication devices 1110B, and 1110B′ and the stationary wireless communication device 1112B communicate wirelessly with the access point 1104B. The mobile wireless communication device 1110C and the stationary wireless communication device 1112C communicate wirelessly with the access point 1104C. The mobile wireless communication devices (1110A, 1110A′, 1110A″, 1110B, 1110B′, 1110C) may be mobile computers such as laptops, tablets, or handhelds; or personal digital assistants (PDAs); or other mobile or portable digital device. The mobile wireless communication devices can readily roam from one access point to another. The stationary wireless communication devices (1112A, 1112B, 1112C) may be a stationary computer, such as a desktop or tower personal computer; or other stationary digital device. The stationary wireless communication devices do not as easily roam from one access point to another as they are typically heavier and have multiple modules (e.g., keyboard, mouse, monitor, computer, etc.) interconnected by cables. However, the stationary wireless communication devices can be moved with some effort to another location such as from one WLAN to another.

The wireless access points (WAPs) 1104A-1104C may be a wireless access point switch, a wireless access point router, or a cable modem with a wireless access point router. A wireless access point router typically includes a firewall with access security to protect unauthorized access to the WLAN 1102A-1102C. The wireless access point may include a personal computer coupled to a wireless access point router such as illustrated by the wireless access point 1104C. Using cables and wires, the wireless access points may couple directly to the wired network backbone 1106 or indirectly to the wired network backbone 1106 through other networking equipment. For example, wireless access point 1104A couples directly to the wired network backbone 1106. Wireless access point 1104B couples indirectly to the wired network backbone 1106 through switch 1120. Another digital device, such as computer 1122, may couple into the switch 1120 to share access to the wired network backbone 1106 with the WLAN 1102B.

The wireless access points may couple to the wired network backbone 1106 using Ethernet cables and a portion of the wired network backbone 1106 may be an Ethernet network in one embodiment of the invention. In other embodiments of the invention, a modem may couple the wireless access points to the wired network backbone 1106. In one embodiment, a cable modem couples to the wired network backbone 1106 using coaxial cable and a portion of the wired network backbone 1106 is a cable network. One or more wireless access points may couple to the cable modem using Ethernet cables. In another embodiment, a digital subscriber line (DSL) modem couples to the wired network backbone 1106 using plain old telephone (POT) cables and a portion of the wired network backbone 1106 is a telephone network. One or more wireless access points may couple to the DSL modem using Ethernet cables. In another embodiment, a dial up modem (e.g., 56 k baud) couples to the wired network backbone 1106 using a plain old telephone (POT) cable and a portion of the wired network backbone 1106 is the telephone network. A wireless access point may couple to the dial up modem using a cable.

The wired network backbone 1106 may also couple using cables/wires to one or more wired network computers 1125 and/or one or more servers 1126. The wired network backbone 1106 may also couple to the internet or be considered a part thereof.

FIG. 11B illustrates concentric rings around a centered antenna for various exemplary wireless communication systems. The concentric rings of FIG. 11B illustrate the difference in an idealized typical radial communication distance R from the centered antenna for the various wireless communication systems. Besides differences in carrier frequencies, the various wireless communication systems differ in a number of other ways.

WLAN and BlueTooth are unlicensed frequency bands. That is, no license is required from the Federal Communication Commission (FCC) to operate in these carrier frequency ranges. Macrocell, microcell, and picocell cellular systems, collectively referred to herein as cellular wireless communication systems, require the service providers to pay a license fee to the FCC.

BlueTooth wireless communication system typically does not provide any handoff from one antenna to another as the signal strength changes, such as when a mobile device is moved. The communication link between a base antenna and a mobile antenna is simply lost. When a device moves or roams in a WLAN communication system, a handoff may be provided from one antenna to another within a limited geographic area, such as a building. However with greater mobility, handoffs from one service area to another are not expected in WLAN communication systems, such as from one coffee shop on one corner to another coffee shop at an opposite corner. Seamless service is expected from cellular wireless communication systems so that handoffs are typically provided to a user over a wide geographical coverage area. The antennae in cellular wireless communication systems are arranged to provide cellular service coverage and handoffs can occur from one cell to another or between macrocell, microcell, and picocell cellular systems.

The idealized typical radial communication distance R differs over the various wireless communication systems as is illustrated in FIG. 11B. WLAN's idealized typical radial communication distance R is typically on the order of one hundred to two hundred feet. In contrast, BlueTooth's idealized typical radial communication distance R is typically limited to about ten feet. The idealized typical radial communication distance R in cellular wireless communication systems is much greater than that of WLAN and BlueTooth wireless communication systems.

Referring now to FIG. 11C, a wireless adapter card 1150 for a mobile or stationary wireless communicating device is illustrated. The wireless adapter card 1150 may include a printed circuit board (PCB) 1152, a radio frequency transceiver integrated circuit 1154, a baseband digital signal processing integrated circuit 1156, a connector 1158, and an antenna 1160 coupled together as shown and illustrated in FIG. 11C. Wireless access points may include similar elements as that of the wireless adapter card 1150 and further include additional digital integrated circuits and connectors to support additional features and users.

Between the radio frequency transceiver integrated circuit 1154 and the baseband digital signal processing integrated circuit 1156 is a serial digital interface 1162. The serial digital interface 1162 reduces pin count ordinarily required by a parallel digital interface and reduces noise ordinarily generated by a parallel digital interface. As illustrated in FIG. 11C, the serial digital interface 1162 is bidirectional having a pair of serial data connections. Over one serial data connection, the radio frequency transceiver integrated circuit 1154 communicates data to the baseband digital signal processing integrated circuit 1156. Over another serial data connection, the baseband digital signal processing integrated circuit 1156 communicates data to the radio frequency transceiver integrated circuit 1154.

The baseband digital signal processing integrated circuit 1156 may have a parallel or serial data connection with the connector 1158 which can be shielded and may have a lower data rate to communicate with a host system. The connector 1158 may be an edge connector formed as part of the PCB 1152 such as for a PCI bus, a PC Card Connector for a PC Card Slot, a PCMCIA connector for a PCMCIA slot, a USB connector, a Firewire/iLink/IEEE 1394 connector, or an Ethernet connector. The baseband digital signal processing integrated circuit 1156 may have a media access controller (MAC) to interface to the digital device connected to the connector 1158.

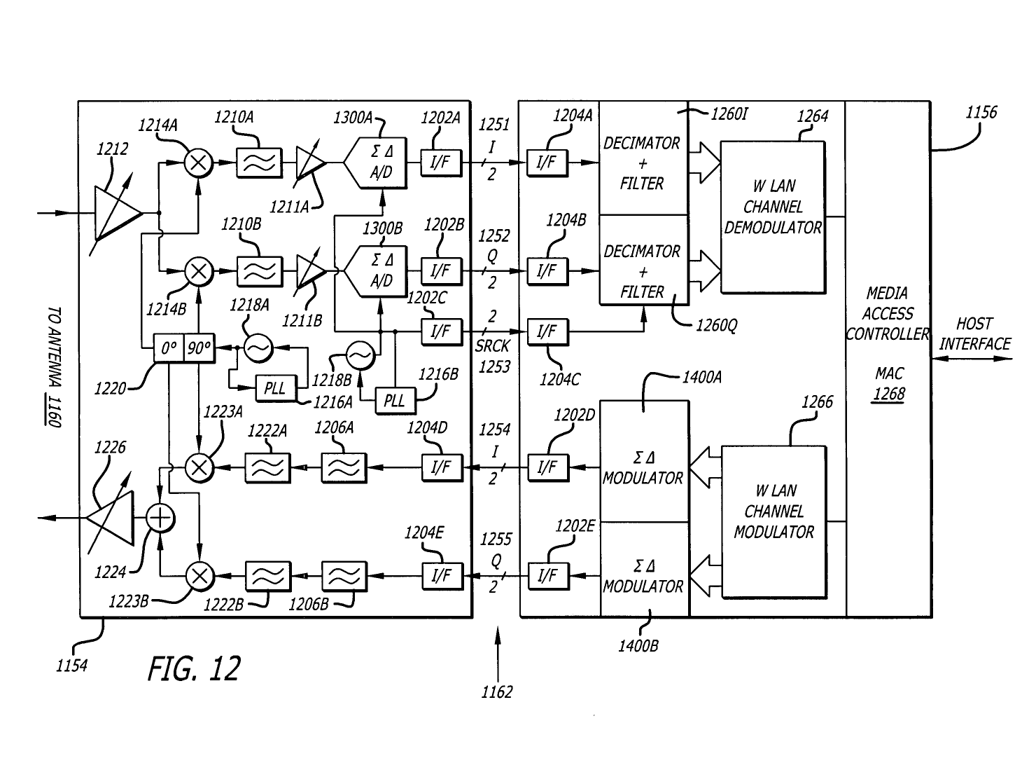

Referring now to FIG. 12, a sigma-delta A/D and sigma-delta digital interface 1162 between the wireless LAN radio frequency integrated circuit 1154 and the base band digital signal processing integrated circuit 1156 is illustrated. The wireless LAN radio frequency integrated circuit 1154 is a transceiver integrated circuit to both receive signals over a wireless LAN and to transmit signals over a wireless LAN. The sigma-delta A/D and sigma-delta digital interface 1162 is a bidirectional serial digital interface between the radio frequency transceiver integrated circuit 1154 and the processor integrated circuit 1156.

The digital interface 1162 is compatible with wireless networking communication system signals, such as IEEE 802.11a/g WLAN standard based signals. Embodiments of the invention enable the digital interface 1162 to transfer digital data serially between the RF transceiver IC 1154 and the base band digital signal processing integrated circuit 1156.

Previously, an analog interface with the base band chip was available for data signal flow. To accommodate the analog interface, large analog blocks were used to implement an analog to digital converter in one signal flow direction and a digital to analog converter in an opposite direction. The analog signals in the analog interface typically had poor noise immunity as they were susceptible to the surrounding noise.

Embodiments of the invention with the digital interface 1162, reduce the total silicon area used by circuitry in the RF transceiver IC 1154 and the base band digital signal processor IC 1156 combined, reduce the total power consumption, and improve the integrated circuit yield of the Base Band DSP IC 1156 because it is mostly a pure digital integrated circuit with little or no mixed signal circuitry. The digital interface 1162 allows extended bus lengths between the RF transceiver IC 1154 and the Base Band DSP IC 1156 over the prior art, due to improved noise immunity of the digital signals from the surrounding noise sources.

The RF transceiver IC 1154 includes a pair of sigma-delta A/D modulators 1300A-1300B, low voltage differential signal output drivers 1202A-1202C, low voltage differential signal input receivers 1204C-1204D, passive filters 1206A-1206B to provide its part of the digital interface 1162, and a sigma-delta clock generated formed out of a programmable phase locked loop (Frac-N PLL) 1216B and a local oscillator 1218B coupled together as shown and illustrated in FIG. 12.

The RF transceiver IC 1154 may further include a programmable gain low noise amplifier 1212; mixers 1214A-1214B also referred to as down converters; a pair of passive filters 1210A-1210B; a pair of programmable gain amplifiers 1211A-1211B; programmable power amplifier 1226; a pair of passive analog filters 1206A-1206B; a pair of relaxed filters 1222A-1222B; a pair of mixers 1223A-1223B, also referred to as upconverters; an a combiner or analog summer 1224, a programmable phase locked loop (Frac-N PLL) 1216B and a local oscillator 1218B coupled together as shown and illustrated in FIG. 12. A serial peripheral interface (SPI) (not shown in FIG. 12 but shown in FIGS. 3A, 4, 5, 6A, 7, and 8) may also be provided for control signaling between the integrated circuit 1154 and the integrated circuit 1156.

Also, the RF transceiver IC 1154 may optionally include clock/data recovery with the low voltage differential signal input receivers 1204C-1204D, such as CDR 350 illustrated in FIG. 6B, for improved performance. However, this is not necessary as the analog filtering provided in the RF transceiver IC 1154 is sufficient to reconstruct an analog signal from the serial digital waveforms on I 1254 and Q 1255 provided that the low voltage differential signal input receivers 1204C-1204D provide efficient reception of the one and zeroes thereon and conversion to plus and minus voltage levels. The optional clock/data recovery would improve performance if the duty cycle or the period of data bits varies and would remove jitter if the data were to be sampled with a cleaner clock signal.

The baseband DSP IC 1156 includes a pair of sigma-delta digital modulators 1400A-1400B, low voltage differential signal output drivers 1202D-1202E, low voltage differential signal input receivers 1204A-1204C, and decimator/filters 1260I,1260Q coupled together as shown and illustrated in FIG. 12 to support the digital interface 1162. The baseband DSP IC 1156 further includes WLAN channel demodulators 1264, WLAN channel modulators 1266, and a media access controller (MAC) 1268 coupled together as shown and illustrated in FIG. 12.

In the RF transceiver IC 1154, the programmable phase locked loop (Frac-N PLL) 1216B couples to and controls the local oscillator 1218B. The local oscillator 1218B selectively generates a sigma-delta clock SDCK which is coupled to the sigma-delta modulators 1300A-1300B and into the low voltage differential output driver 1202C to generate the output sigma-delta clock signal SDCK 1253 which is coupled into the baseband DSP IC 1156. The sigma-delta clock signal SDCK is provided to the decimator/filter blocks 1260I,1260Q in the base band DSP IC 1156.

The pair of passive analog filters 1206A-1206B filter out high frequency noise and generate an analog output signal from the serial bit steam of data. The I and Q analog signals are generated by the low pass filters 1206A-1206B at a baseband frequency and are coupled into the pair of relaxed filters 1222A-1222B, respectively.

The pair of relaxed filters 1222A-1222B further filter the I and Q analog signals over a wider pass-band in comparison with the low pass filters 1206A-1206B to complete the analog signal reconstruction from the digital waveform and to suppress wide band large out-of-band noise generated by the sigma-delta modulators 1400A-1400B (i.e., to suppress the noise-shaped spectrum of the modulator output, the digital waveform). The group delay variation is less in the relaxed filters 1222A-1222B resulting in less signal distortion in the output signal. The filtered output from the pair of relaxed filters 1222A-1222B is then coupled into the pair of mixers 1223A-1223B, respectively.

The pair of mixers 1223A-1223B receive the I and Q analog signals at a baseband frequency and up-convert them to the desired carrier frequency for transmission over a given wireless communication system. The carrier frequency is selected by using the programmable phase locked loop (Frac-N PLL) 1216A to drive the local oscillator 1218A. The local oscillator 1218A, having a selectable carrier frequency, has its oscillation output coupled to one of the clock inputs of the pair of mixers 1223A or 1223B. The oscillation output from the local oscillator 1218A is also coupled into a phase shifter 1220 and one of the clock inputs of the pair of down converters 1214A or 1214B. The phase shifter 1220 shifts the generated clock out of phase by ninety degrees. The output from the phase shifter is coupled into the other one of the pair of mixers 1223A or 1223B and the other one of the down converters 1214A or 1214B. The output from the pair of mixers 1223A-1223B is coupled into the combiner 1224 to combine the I and Q analog signals at the carrier frequencies into a single radio frequency analog signal which is coupled into the power amplifier 1226.

The power amplifier 1226 receives the radio frequency analog signal and amplifies it into a radio frequency analog output signal with increased power output that is coupled into the antenna for radiating. The digital interface allows the power amplifier 1226 to be integrated as part of the transceiver IC 1154, because other large analog circuitry was eliminated (e.g., the parallel ADC and active analog filters) and power was conserved. The integration of the power amplifier with the transceiver may avoid using other circuitry such as isolators and power detectors. The integration of the power amplifier with the transceiver also enables predistortion of the transmit signals, in a closed or open loop fashion, and therefore can improve transmitter performance.

The programmable phase locked loop (Frac-N PLL) 1216A couples to and controls the local oscillator 1218A. The local oscillator 1218A selectively generates a carrier frequency signal for the carrier frequency of the selected WLAN system which is coupled into the pair of mixers 1214A-1214B. It is this carrier frequency signal that is used to strip away the carrier frequency from the received analog radio frequency signals. In other words, with the carrier frequency signal the mixers may extract analog data signals at baseband frequencies from the received analog signals at the center of the carrier frequency.

The passive front-end low pass filters 1206A-1206B in the transmit paths protect the active filters that follow from sharp edges of the one-bit sigma delta modulators, and thereby easily achieve out of band spectral requirements. Thus, the active low-pass filters 1222A-1222B that follow may be of a lower order (i.e., relaxed) or eliminated in certain cases.

The digital interface also allows the receiving path low-pass channel filters 1210A-1210B to be relaxed and do part of channel filtering digitally after the decimators 1260I/1260Q or in the last stage of decimation.

In the RF IC 1154, the programmable gain low noise amplifier 1212 receives analog radio frequency signals from a wireless networking communication system, amplifies the signals and couples them to the mixers 1214A-1214B. The mixers 1214A-1214B are used to down convert the received I and Q analog data signals from the carrier frequencies of the respective wireless networking communication system channel into baseband signals. That is, the mixers strip away the carrier frequency from the I and Q analog signals. In other words, the mixers extract the analog data signals at baseband frequency from the received analog signals at the carrier frequencies. The mixers couple the baseband analog data signals into the pair of passive filters 1210A-1210B.

The passive filters 1210A-1210B are analog prefilters that protect the sigma-delta data modulators 1300A-1300B from high interference signals. The passive filters 1210A-1210B are low-pass filters in the baseband frequency of interest. These passive analog filters 1210A-1210B filter out the unwanted frequency of signals generated by the down converters 1214A-1214B. The filtered outputs from the passive filters 1210A-1210B are coupled into the programmable gain amplifiers 1211A-1211B.

The programmable gain amplifiers 1211A-1211B, are used to adjust the gain and effectively compress the dynamic range in front of the sigma-delta data modulators 1300A-1300B. The amplified baseband analog data signals from the programmable gain amplifiers 1211A-1211B are coupled into the pair of sigma-delta modulators 1300A-1300B.

The sigma-delta modulators 1300A-1300B are over sampling quantizers and essentially convert the baseband analog data signals from the programmable gain amplifiers 1211A-1211B into serial digital bit streams. The serial digital bit streams from the sigma-delta modulators 1300A-1300B are coupled into the low voltage differential signal output drivers 1202A-1202C.

The low voltage differential output drivers 1202A-1202B each receive a single ended serial digital bit stream (I and Q bit streams) from the sigma-delta modulators 1300A-1300B having a high voltage swing between the pair of high voltage difference logic levels (e.g., ground and VCC). In response to the single ended digital signal with the high voltage swing between the pair of high voltage difference logic levels, the low voltage differential output drivers 1202A-1202B generate a double ended low voltage swing differential signals (I 1251 and Q 1252 of the serial digital interface 1162) between a pair of low voltage difference logic levels. This is discussed in greater detail with reference to the low voltage differential output drivers 910I,910Q illustrated in FIG. 9A.

The concept of the digital interface may be extended to Low-IF transceivers with a low-IF analog interface. The low-IF analog interface is replaced with a digital n-bit (n≧1) interface, the n-bits being generated by band-pass sigma-delta modulators with an n-bit quantizer.

Clock information may be embedded in the digital bit stream so that a separate clock is not required for the receiver section of the digital interface.

In one embodiment of the invention, the received signal strength may be estimated from the output of the sigma delta A/D modulator by averaging, and digitally controlling the receiver gain, with a control loop being implemented locally instead of by the base band DSP integrated circuit. Otherwise, the receiver gain may digitally controlled by the baseband IC 1156 to try to maintain an average received signal strength.

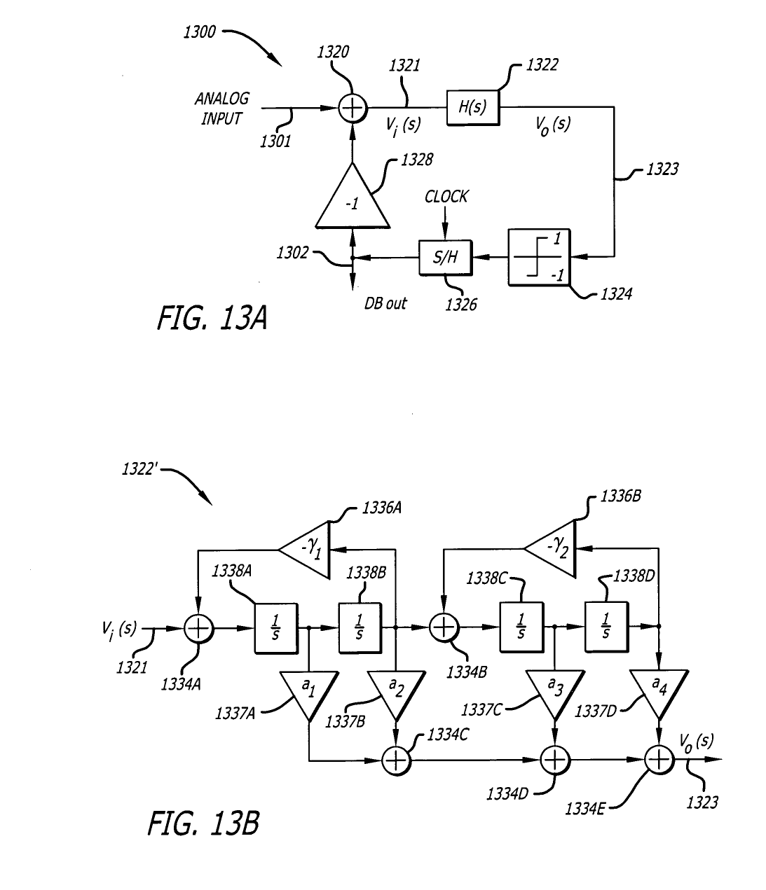

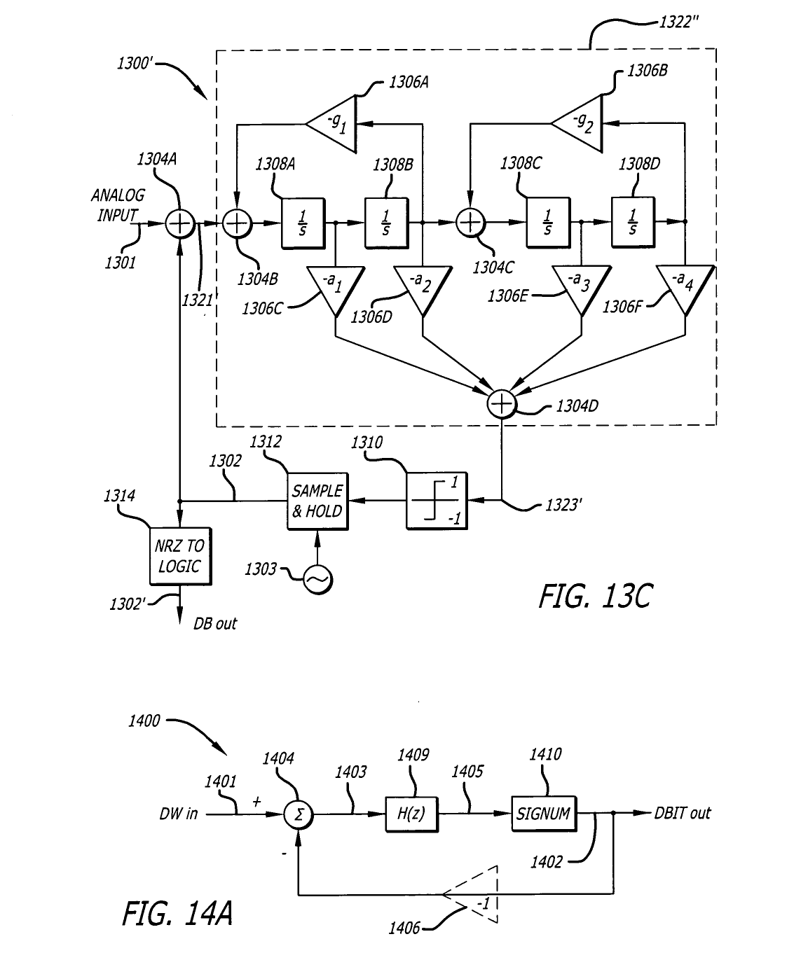

Referring now to FIG. 13A, an exemplary continuous time sigma-delta A/D modulator 1300 is illustrated. The sigma-delta A/D modulator 1300 receives an analog input 1301 and generates a modulated one bit digital output DBout 1302. Effectively, the analog input signal is transformed into a serial digital bit output data stream. The sigma-delta A/D modulator 1300 includes an analog summer 1320, a loop filter 1322, a one bit quantizer 1324, an analog sample and hold circuit 1326, and an inverting analog amplifier 1328 coupled together as shown and illustrated in FIG. 13A. The inverting analog amplifier 1328 may be incorporated into the amplifiers of the active loop filter by using inverting gain amplifiers.

The loop filter 1322 is an active filter and has a desired response based on the order and filter coefficients selected. The loop filter 1322 filters both the analog input signal and the quantization noise generated by the quantizer 1324. Thus, the loop filter 1322 may be designed to shape the quantization noise from the quantizer 1324. The order and coefficients of the loop filter 1322 may be selected by simulating the desired noise response and signal response of the loop filter 1322.

For WLAN applications, a fourth order loop filter was selected having a filter response of H(s) as follows:

$$H ( s ) = \frac{Vo ( s )}{Vi ( s )} = \frac{{a}_{1} {s}^{3} + {a}_{1} {s}^{2} + ( {a}_{1} {v}_{2} + {a}_{3} ) s + ( {a}_{2} {v}_{2} + {a}_{4} )}{( {s}^{2} + {v}_{1} ) ( {s}^{2} + {v}_{2} )} .$$

Performing a Z transform on this continuous time equation for H(s), one may obtain the discrete time equation H(z) of the loop filter transfer function. The noise transfer function (NTF) of the loop filter may be determined from the equation

$$NTF ( z ) = \frac{1}{1 + H ( z )}$$

using the loop filter transfer function H(z). The signal transfer function (STF) of the loop filter may be determined from the equation

$$STF ( z ) = \frac{H ( z )}{1 + H ( z )}$$

using the loop filter transfer function H(z) as well. With the selected fourth order loop filter H(s), the feedback coefficients v₁ and v₂ produce zeroes in the noise transfer function NTF(z) of the loop filter. These zeroes are positioned in the signal passband in order to improve the signal to noise ratio (S/N).

FIG. 13B illustrates the basic elements of a fourth order loop filter 1322′ with the transfer function of H(s) from above in the time domain and H(z) in the z or discrete time domain. The loop filter 1322′ includes analog summers 1334A-1334E, inverting amplifiers 1336A-1336B, non-inverting amplifiers 1337A-1337D, and analog integrators 1338A-1338D coupled together as shown and illustrated in FIG. 13B. Analog summers 1334C-1334E may integrated into one four input analog summer. The loop filter 1322′ receives an analog input signal Vi(s) 1321 and generates an analog output signal Vo(s) 1323. The loop filter 1322′ designed for WLAN applications may be integrated into the sigma delta modulator 1300 of FIG. 13A.

Referring now to FIG. 13C, a preferred embodiment of a sigma-delta modulator 1300′ to provide analog to single bit digital conversion within the RF integrated circuit is illustrated. With some circuit minimization, the loop filter 1322′ of FIG. 13B has been integrated into the sigma delta modulator as loop filter 1322″ as shown and illustrated in FIG. 13C. The sigma-delta modulator 1300′ may be used as the sigma delta modulators 1300A and 1300B within the RF integrated circuit 1154 illustrated in FIG. 12.

The sigma-delta modulator 1300′ receives an analog input signal 1301 and generates a one-bit NRZ digital output 1302. The sigma-delta modulator 1300 may operate with a 640 mega-hertz clock rate generated by the clock generator 1303 for an expected zero to 8.5 megaHertz signal bandwidth for a WLAN application such as IEEE 802.11a/g.

The sigma-delta modulator 1300′ includes analog summers 1304A-1304D, inverting amplifiers 1306A-1306F, analog integrators 1308A-1308D, a one bit quantizer 1310, and a sample and hold circuit 1312 coupled together as shown and illustrated in FIG. 13. In the preferred embodiment of the sigma-delta modulator 1300, the gain g1 and g2 of the inverting amplifiers 1306A and 1306B may be 0.0015 and 0.006, respectively. In which case, the gain a1, a2, a3, and a4 of the inverting amplifiers 1306C-1306F may be n1, n2, n3-a1g2, and n4-a2g2, respectively, where n1=0.671209, n2=0.2442138, n3=0.05641717, and n4=0.006278019. The sigma-delta modulator 1300′ may further include an NRZ to logic level conversion circuit 1314 to convert bipolar or NRZ signals (i.e., −1 and +1) received from node 1302 to binary logic levels representing a logical one or zero on the DBITout 1302′.

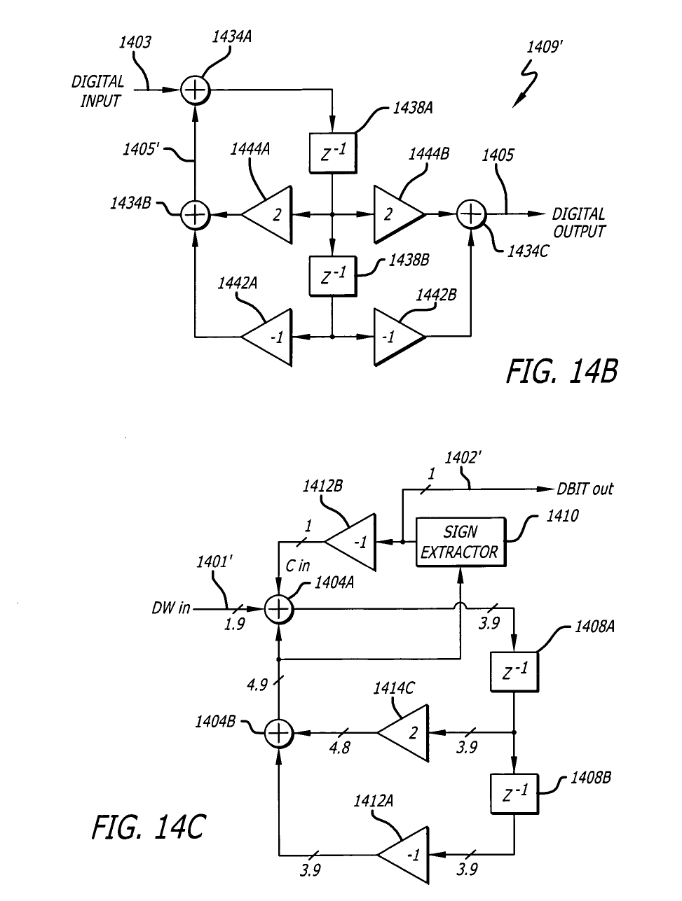

Referring now to FIG. 14A, an exemplary sigma-delta digital modulator 1400 is illustrated for use in the baseband DSP integrated circuit 1156. The sigma-delta digital modulator 1400 receives a multibit digital word input DWin 1401 and generates a modulated one bit digital output DBITout 1402. Effectively, the multibit digital word is transformed into a serial digital bit stream. The sigma-delta digital modulator 1400 includes a digital adder 1404 performing subtraction (i.e., a subtractor), a digital loop filter 1409, and a sign extractor SIGNUM 1410 coupled together as shown and illustrated in FIG. 14A. For the digital adder 1404 to perform subtraction, an inverter may be used at one of its digital inputs to invert the bits, such as optional inverter 1406 at the one input illustrated in FIG. 14A.

The loop filter 1409 is a digital filter and has a desired response based on the order and filter coefficients selected. The order and coefficients of the loop filter 1409 may be selected by simulating the desired noise response (NTF(z)) and signal response (STF(z)) of the filter for a given clock frequency.

For WLAN applications, a second order digital loop filter was selected having a filter response of H(z) as follows:

$$H ( z ) = \frac{2 {z}^{- 1} - {z}^{- 2}}{1 - 2 {z}^{- 1} + {z}^{- 2}} .$$

In this case, the noise transfer function (NTF) of the loop filter may be determined from the equation

$$NTF ( z ) = \frac{1}{1 + H ( z )} = {( 1 - {z}^{- 1} )}^{2}$$

using this loop filter transfer function H(z).

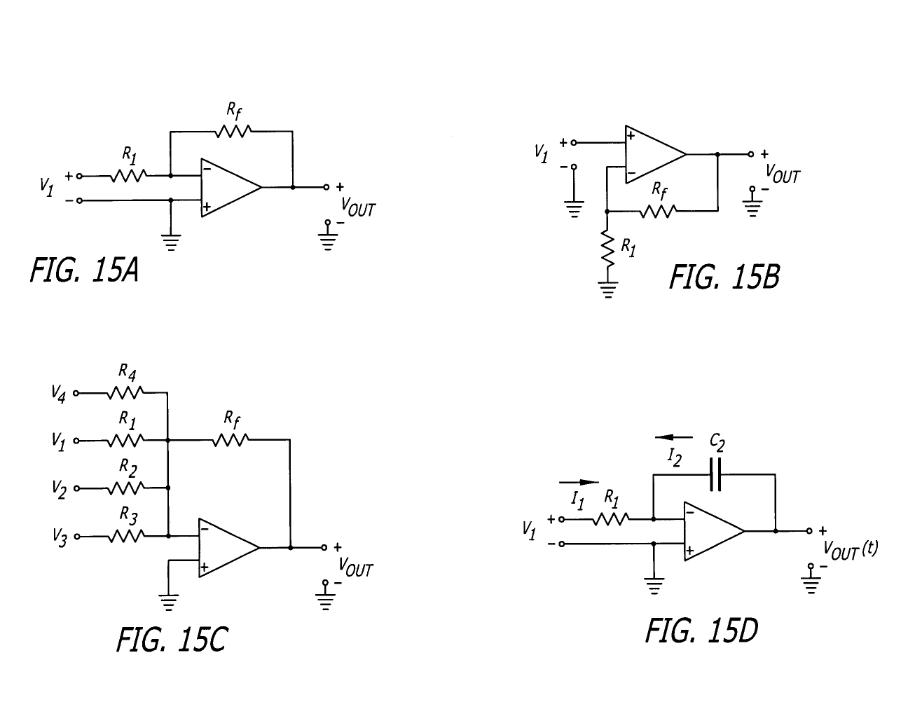

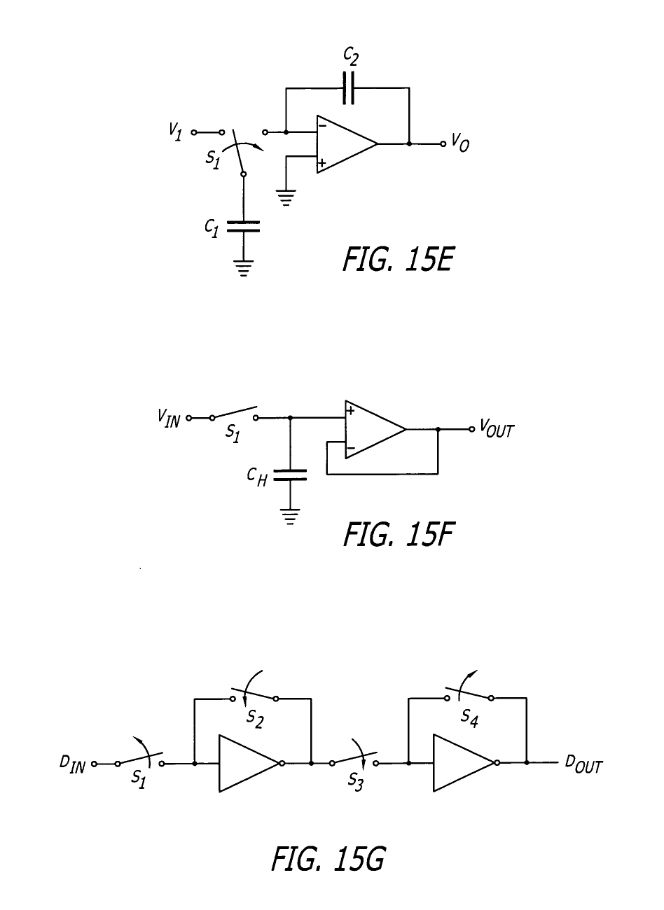

FIG. 14B illustrates the basic elements of an exemplary second order digital loop filter 1409′. The second order digital loop filter 1409′ includes digital adders 1434A-1434C, digital delay registers 1438A-1438B, sign changers 1442A-1442B, and bit shifters 1444A-1444B coupled together as shown and illustrated in FIG. 14B. Between each element or included as an output or input or input of an element may be a register (not shown in FIG. 14B, see the drawing and the description of FIG. 15G below) or latch to hold the digital number at a node for a sample cycle while it is evaluated. The second order digital loop filter 1409′ can be minimized by noting that the digital signal at the output 1405 is the same as the digital signal at node 1405′ due to the mirror image in the functional blocks. Thus, the digital adder 1434C, the sign changer 1442B, and the bit shifter 1444B may be eliminated and the output 1405′ selected instead.

Referring now to FIG. 14C, a preferred embodiment of a sigma-delta digital modulator 1400′ to convert a multibit digital word into a single bit is illustrated. With some circuit minimization, the second order loop filter 1409′ of FIG. 14B has been integrated into the sigma delta digital modulator as shown and illustrate in FIG. 14C. The sigma-delta digital modulator 1400′ may be used as the sigma delta digital modulators 1400A and 1400B within the baseband DSP integrated circuit 1156 illustrated in FIG. 12.

The sigma-delta digital modulator 1400′ receives a multibit digital word input DWin 1401 and generates a one-bit digital output DBITout 1402′. The sigma-delta digital modulator 1400′ may operate with a 640 mega-hertz clock rate generated by a clock generator (not shown in FIG. 14C) for a WLAN application. In which case, the multibit digital word input 1401 is upsampled to a 640 megaHertz clock rate and the one-bit digital output DBITout 1402′ that is generated is modulated at 640 megabits per second. To achieve 40 mega-samples per second, the multibit digital word input DWin 1401 is held or repeated for 16 samples or clock cycles in a row by a repeat function.

The sigma-delta digital modulator 1400′ includes digital adders 1404A-1404B, digital delay registers 1408A-1408B, a sign extractor 1410, sign changers 1412A-1412B, and a bit shifter 1414 coupled together as shown and illustrated in FIG. 14C. Between each element or included as an output or input or input of an element may be a register (not shown in FIG. 14C, see the drawing and the description of FIG. 15G below) or latch to hold the digital number at a node for a sample cycle while it is evaluated.

The number of bits (i.e., the word length) and the position of the decimal point and sign bit varies in the sigma-delta digital modulator 1400′. The word length is indicated in FIG. 14 in the format of X.Y where X is the number of bits in the digital word before the decimal point including one sign bit and Y is the number of bits in the digital word after the decimal point. Adders 1404A-1404B illustrated in FIG. 14C have 13 bit precision to receive a 10 bit input, a 13 bit input, and a carry bit input.

The sign changers 1412A-1412B may be hard wired and simply invert the sign of the digital input number, passing through other bits, or they may multiply the digital input number by negative one, or add one to the digital input number in order to perform negation of a particular digital or binary number format input. That is, the binary number format may be in a sign-magnitude form, a twos-complement form, or a ones-complement form in order to represent positive and negative values, requiring different methods of negation. In a preferred embodiment, the binary number format is a twos-complement form in order to represent positive and negative values. The sign changers 1412A-1412B may also be referred to herein as sign inverters, negators or multipliers. The sign changer 1412A inverts the sign bit and passes through the other bits from the digital delay register 1408B into the input of the digital adder 1404B. The sign changer 1412B generates a single bit output that may be coupled into the carry input Cin of the digital adder 1404A.

The bit shifter 1414 shift the bits of the digital input by one position in the direction of the most significant bit (e.g., to the left) to effectively multiply the digital input by two. Otherwise, a multiplier may be used to multiply the digital input number by two.

The sign extractor 1410 simply extracts the most significant bit (MSB) of its digital input in order to generate the one bit output DBITout 1402′.

FIGS. 15A-15G illustrate exemplary schematics of functional blocks that may be used to form the elements of the sigma-delta modulators of FIGS. 13A-C and 14A-C.

FIG. 15A is a schematic of an inverting analog amplifier. In FIG. 15A, Vout=−(Rf/R1)V1. If unitary gain is desired Rf is set equal to R1.

FIG. 15B is a schematic of a non-inverting analog amplifier. In FIG. 15A, Vout=V1(1+Rf/R1).

FIG. 15C is a schematic of a four input analog summing amplifier. In FIG. 15C, Vout=−Rf(V1/R1+V2/R2+V3/R3+V4/R4). In other instances, less than four inputs are required. For example to provide a three input analog summer, resistor R4 is eliminated and Vout=−Rf(V1/R1+V2/R2+V3/R3). To provide a two input analog summer, resistors R3 and R4 are eliminated and Vout=−Rf(V1/R1+V2/R2). In order to provide unity gain in the analog summer, the resistors R1, R2, R3, and R4 are all set equal to Rf.

FIG. 15D is a schematic of an analog integrator. In FIG. 15D,

$${V}_{out} ( t ) = \frac{- 1}{R1 C2} {\int }_{0}^{t} {V}_{1} ( t ) \partial t + {V}_{out ( 0 )} .$$

To provide a unity gain, R1C2 is set equal to one.

With referenced to FIG. 15E, a switched capacitor integrator may alternatively be used as illustrated. The gain provided by the switched capacitor integrator of FIG. 15E is a function of the sampling period T. In which case, R1=T/C1 which is substituted into the equation of

$${V}_{out} ( t ) = \frac{- 1}{R1 C2} {\int }_{0}^{t} {V}_{1} ( t ) \partial t + {V}_{out ( 0 )} .$$

With this substitution, the equation becomes

$${V}_{out} ( t ) = \frac{- C1}{( T * C2 )} {\int }_{0}^{t} {V}_{1} ( t ) \partial t + {V}_{out ( 0 )} .$$

FIG. 15F is a schematic of a simple analog sample and hold circuit. Switch S1 switches closed to sample the input Vin and stores its voltage on the holding capacitor CH. A voltage follower buffer amplifier buffers the holding capacitor CH from an output load and drives the voltage on the holding capacitor onto the output node Vout.

FIG. 15G is a schematic of a simple D type flip flop element for one bit of a digital register that may be used to provide a delay of one time sample in a digital binary number. Multiple D type flip flops are instantiated in parallel with the respective switches being similarly clocked in order to form a register.]

While, the invention has been described and illustrated as using sigma-delta modulators. Other modulators that receive an analog input signal and have a single bit output to provide a serial digital data stream may be used. For example, the sigma-delta modulators may be delta modulators, in another embodiment. In yet another embodiment, the sigma-delta modulators may be modulating analog-to-digital converters with a single digital bit output to provide the serial bit stream.

Additionally, while certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. For example, it is possible to implement the invention or some of its features in hardware, firmware, software or a combination thereof where the software is provided in a processor readable storage medium such as magnetic, optical, or semiconductor storage. While the invention has been described in particular embodiments, the invention should not be construed as limited by such embodiments. Rather, the invention should be construed according to the claims below.

1. A wireless radio for wireless networking communication systems, the wireless radio comprising:
a radio frequency transceiver integrated circuit to receive a first wireless network radio signal and to transmit a second wireless network radio signal;
a processor integrated circuit to decode data from the first wireless network radio signal and to encode data for the second wireless network radio signal; and
a bidirectional serial digital interface between the radio frequency transceiver integrated circuit and the processor integrated circuit, the bidirectional serial digital interface having
a first serial data connection to couple serial digital data from the radio frequency transceiver integrated circuit to the processor integrated circuit, and
a second serial data connection to couple serial digital data from the processor integrated circuit to the radio frequency transceiver integrated circuit.

2. The wireless radio of claim 1, wherein
the radio frequency transceiver integrated circuit and the processor integrated circuit are coupled to a printed circuit board; and
the wireless radio further comprises
an antenna coupled to the radio frequency transceiver integrated circuit, the antenna to receive the first wireless network radio signal and to transmit the second wireless network radio signal.

3. The wireless radio of claim 2, further comprising:
a connector coupled to the processor integrated circuit, the connector to couple the wireless radio to a host system.

4. The wireless radio of claim 2, further comprising:
a connector coupled to the processor integrated circuit, the connector to couple the wireless radio to a wired network.

5. The wireless radio of claim 1, wherein the bidirectional serial digital interface has a low voltage output swing such that
the serial digital data of the first serial data connection has a low voltage output swing, and
the serial digital data of the second serial data connection has a low voltage output swing.

6. The wireless radio of claim 5, wherein
the low voltage output swing between a high logic level and a low logic level is less than an output swing between a high logic level and a low logic level of a three volt complementary metal oxide semiconductor (CMOS) process technology.

7. The wireless radio of claim 5, wherein
the low voltage output swing between a high logic level and a low logic level is less than an output swing between a high logic level of 1.8 volts and a low logic level of 0.2 volts.

8. The wireless radio of claim 1, wherein
the bidirectional serial digital interface has a differential signal interface such that
the first serial data connection is double ended and the serial digital data is a differential data signal, and
the second serial data connection is double ended and the serial digital data is a differential data signal.

9. The wireless radio of claim 8, wherein
the bidirectional serial digital interface further has a low voltage output swing such that
the serial digital data of the first serial data connection has a low voltage differential output swing, and
the serial digital data of the second serial data connection has a low voltage differential output swing.

10. The wireless radio of claim 9, wherein
the low voltage differential output swing is at least 100 milli-volts.

11. A wireless adapter for wireless networking communication systems, the wireless adapter comprising:
a radio frequency transceiver integrated circuit including
a modulating analog to digital converter with an analog input and a serial digital output, the analog input to receive a wireless network radio signal,
an output driver having an input coupled to the serial digital output of the modulating analog to digital converter, the output driver having a digital output,
an input receiver having a digital input, the input receiver having a serial digital output;
a data recoverer having an input coupled to the serial digital output of the input receiver, the data recoverer having a serial digital output;
a low pass filter having an input coupled to the serial digital output of the data recoverer, the low pass filter having an analog output;
a mixer having an input coupled to the analog output of the low pass filter, the mixer having an analog output; and
an amplifier having an input coupled to the analog output of the mixer, the amplifier having an output to couple to an antenna to transmit a wireless network radio signal;
and
a processor coupled to the digital output of the output driver and the digital input of the input receiver of the radio frequency transceiver integrated circuit.

12. The wireless adapter of claim 11, wherein
the processor includes
an input receiver coupled to the digital output of the output driver of the radio frequency receiver integrated circuit, the input receiver having a digital input to couple to the digital output of the output driver of the radio frequency receiver integrated circuit, the input receiver having a serial digital output,
and
an output driver coupled to the digital input of the input receiver of the radio frequency receiver integrated circuit, the output driver having a digital output to couple to the digital input of the input receiver of the radio frequency receiver integrated circuit, the output driver having a serial digital input.

13. The wireless adapter of claim 12, wherein
the processor is a digital signal processor and further includes
a decimator coupled to the serial digital output of the input receiver, the decimator having a digital output, and
a demodulator coupled to the digital output of the decimator.

14. The wireless adapter of claim 12, wherein
the processor includes programmable instructions to provide
a decimator coupled to the serial digital output of the input receiver, the decimator having a digital output, and
a demodulator coupled to the digital output of the decimator.

15. The wireless adapter of claim 11, wherein
the modulating analog to digital converter is a single bit sigma delta modulator.

16. The wireless adapter of claim 11, wherein
the modulating analog to digital converter is a single bit delta modulator.

17. A wireless radio transceiver for wireless networking communication systems, the wireless radio transceiver comprising:
an antenna to extract a first wireless network radio signal broadcast from at least one wireless access point in order to receive an analog input signal and to radiate a second wireless network radio signal to the at least one wireless access point in order to transmit an analog output signal,
a radio frequency transceiver integrated circuit coupled to the antenna, the radio frequency transceiver integrated circuit including
a single bit modulator to convert the analog input signal into a first serial digital bit stream, and
a low pass filter to convert a second serial digital bit stream into the analog output signal; and
a digital signal processing integrated circuit coupled to the radio frequency transceiver integrated circuit, the digital signal processing integrated circuit to receive the first serial digital bit stream and decode a digital signal therefrom and to encode a digital signal into the second serial digital bit stream for transmission to the radio frequency transceiver integrated circuit.

18. The wireless radio transceiver of claim 17, wherein
the radio frequency transceiver integrated circuit further includes
a first output driver coupled to the single bit modulator, the output driver to recieve the first serial digital bit stream and drive it out from the radio frequency integrated circuit into the digital signal processing integrated circuit, and
a first input receiver with an output coupled to low pass filter, first input receiver to receive the second serial digital bit stream from the digital signal processing integrated circuit; and
the digital signal processing integrated circuit further includes
a second output driver coupled to the first input receiver of the radio frequency transceiver integrated circuit, the second output driver to drive the second serial digital bit stream to the radio frequency transceiver integrated circuit, and
a second input receiver coupled to the first output driver of the radio frequency transceiver integrated circuit, the second input receiver to receive the first serial digital bit stream.

19. The wireless radio transceiver of claim 18, wherein
the digital signal processing integrated circuit further includes
a decimator coupled to the second input receiver, the decimator to receive the first serial digital bit stream, lower a sampling rate of the first serial digital bit stream and convert the first serial digital bit stream into parallel digital data samples, and
a demodulator coupled to the decimator, the demodulator to digitally demodulate the parallel digital data samples into data words for further signal processing by the digital signal processing integrated circuit.

20. The wireless radio transceiver of claim 19, wherein
the radio frequency transceiver integrated circuit further includes
a first gain amplifier to couple to the antenna to receive the first wireless radio frequency signal;
a down converter coupled to the first gain amplifier, the down converter to extract the first analog signal from the first wireless radio frequency signal;
a passive low pass channel filter coupled to the down converter and the single bit modulator, the passive low pass channel filter to filter out unwanted signal frequencies from the first analog signal;
a relaxed filter coupled to the low pass filter, the relaxed filter to further filter the analog output signal;
a mixer coupled to the relaxed filter, the mixer to up-convert the analog output signal from a baseband frequency to a selectable carrier frequency as the second wireless network radio signal; and
a second gain amplifier coupled to the mixer, the second gain amplifier to amplify the second wireless network radio frequency signal for radiation by the antenna.

21. The wireless radio transceiver of claim 20, wherein
the digital signal processing integrated circuit further includes
a wireless network channel digital modulator to generate a parallel digital word for transmission from a digital signal; and
a digital sigma delta modulator coupled to the wireless network channel digital modulator and the second output driver, the digital sigma delta modulator to modulate the parallel digital word into the second serial digital bit stream.

22. The wireless radio transceiver of claim 18, wherein
the first output driver and the second output driver are differential output drivers to drive differential data signals, and
the first input receiver and the second input receiver are differential input receivers to receive the differential data signals.

23. The wireless radio transceiver of claim 18, wherein
the first output driver and the second output driver are low voltage swing differential output drivers to drive low voltage swing differential data signals, and
the first input receiver and the second input receiver are low voltage swing differential input receivers to receive the low voltage swing differential data signals.

24. The wireless radio transceiver of claim 17, wherein
the single bit modulator is a single bit sigma delta modulator.

25. The wireless radio transceiver of claim 17, wherein
the single bit modulator is a single bit delta modulator.

26. The wireless radio transceiver of claim 17, wherein
the single bit modulator is a single bit analog to digital converter and a modulator coupled together.

27. A radio frequency integrated circuit to couple to an antenna to transmit and to receive wireless network signals, the integrated circuit comprising:
a first amplifier having an input and an output, the input of the first amplifier to couple to an antenna to receive a first wireless network signal, the first amplifier to generate a first analog signal on the output in response to the first wireless network signal;
a down converter having an input and an output, the input of the down converter coupled to the output of the first amplifier, the down converter to extract a second analog signal from the wireless network signal;
a single bit modulator having an input and an output, the input of the single bit modulator coupled to the output of the first amplifier, the single bit modulator to convert the first analog signal into a serial digital bit stream on the output;
a differential output driver having an input and a differential output, the input of the differential output driver coupled to the output of the single bit modulator, the differential output driver to drive the serial digital bit stream onto the differential output of the output driver;
a differential input receiver having a differential input and an output, the differential input receiver to receive a second serial digital bit stream;
a low pass filter having an input and an output, the input of the low pass filter coupled to the output of the differential input receiver, the low pass filter to convert the second serial digital bit stream into a second analog signal on the output of the low pass filter;
a mixer coupled having an input and an output, the input of the mixer coupled to the output of the low pass filter, the mixer to up-convert the second analog signal from a baseband frequency to a wireless network carrier frequency as the second wireless network radio signal on the output of the mixer; and
a second amplifier having an input and an output, the input of the second amplifier coupled to the output of the mixer, the second amplifier to amplify the second wireless network radio frequency signal onto the output of the second amplifier for radiation by an antenna.

28. The integrated circuit of claim 27 wherein
the differential output driver is a low voltage differential signaling transmitter to generate a low voltage differential output signal with a low voltage differential swing.

29. The integrated circuit of claim 28, wherein
the low voltage differential swing is at least 100 milli-volts.

30. The integrated circuit of claim 29, wherein
the low voltage differential output swing between a high logic level and a low logic level is less than an output swing between a high logic level and a low logic level of a three volt complementary metal oxide semiconductor (CMOS) process technology.

31. The integrated circuit of claim 29, wherein
the low voltage differential output swing between a high logic level and a low logic level is less than an output swing between a high logic level of 1.8 volts and a low logic level of 0.2 volts.

32. The integrated circuit of claim 28, wherein
the differential output driver translates first voltage levels of a first output voltage swing of the serial digital bit stream into second voltage levels with a second output voltage swing less than the first output voltage swing.

33. The integrated circuit of claim 27, wherein
the single bit modulator is a single bit delta modulator.

34. The integrated circuit of claim 27, wherein
the single bit modulator is a single bit analog to digital converter and a modulator coupled together.

35. The integrated circuit of claim 27 wherein
the single bit modulator is a single bit sigma delta modulator.

36. A system comprising:
a radio frequency integrated circuit including
a single bit sigma delta modulator having an analog input and a single digital bit output, the single bit sigma delta modulator to convert an analog input signal received from a wireless network at the analog input into a first serial digital bit output stream on the single digital bit output, and
an output driver having an input and an output, the input of the output driver coupled to the single digital bit output of the single bit analog to digital converter, the output driver to drive the first serial digital bit stream onto the output thereof;
and
a processor coupled to the output of the output driver of the radio frequency integrated circuit, the processor to receive the first serial digital bit stream and recover a first digital data signal therefrom.

37. The system of claim 36, wherein
the single bit sigma delta modulator includes
an analog summer having a first input, a second input, and an output, the analog summer to sum the analog signals on the first input and the second input onto the output, the first input of the analog summer to receive the analog input signal from the wireless network;
a loop filter having an input and an output, the input of the loop filter coupled to the output of the analog summer;
a one bit quantizer having an input and an output, the input of the one bit quantizer coupled to the output of the loop filter;
a clocked sample and hold circuit having an input and an output, the input of the sample and hold circuit coupled to the output of the one bit quantizer, the output of the one bit quantizer coupled to the second input of the analog summer, the input of the sample and hold circuit being the output of the single bit sigma delta modulator.

38. The system of claim 37, wherein
the single bit sigma delta modulator further includes
an inverting amplifier having an input and an output, the inverting amplifier coupled between the sample and hold circuit and the analog summer with the input coupled to the output of the sample and hold circuit and the output coupled to the second input of the analog summer.

39. The system of claim 38, wherein
the loop filter of the single bit sigma delta modulator is a fourth order active filter and includes
a second analog summer having a first input, a second input, and an output, the first input coupled to the output of the first analog summer,
a first analog integrator having an input and an output, the input coupled to the output of the second analog summer,
a second analog integrator having an input and an output, the input coupled to the output of the first analog integrator,
a third analog summer having a first input, a second input, and an output, the first input coupled to the output of the second analog integrator,
a third analog integrator having an input and an output, the input coupled to the output of the third analog summer,
a fourth analog integrator having an input and an output, the input coupled to the output of the third analog integrator,
a first inverting gain amplifier with a first gain having an input and an output, the input coupled to the output of the second analog integrator, the output coupled to the second input of the second analog summer,
a second inverting gain amplifier with a second gain having an input and an output, the input coupled to the output of the fourth analog integrator, the output coupled to the second input of the third analog summer,
a first non-inverting gain amplifier with a third gain having an input and an output, the input coupled to the output of the first analog integrator,
a second non-inverting gain amplifier with a fourth gain having an input and an output, the input coupled to the output of the second analog integrator,
a fourth analog summer having a first input, a second input, and an output, the first input coupled to the output of the first non-inverting gain amplifier, the second input coupled to the output of the second non-inverting gain amplifier,
a third non-inverting gain amplifier with a fifth gain having an input and an output, the input coupled to the output of the third analog integrator,
a fifth analog summer having a first input, a second input, and an output, the first input coupled to the output of the fourth analog summer, the second input coupled to the output of the third non-inverting gain amplifier,
a fourth non-inverting gain amplifier with a sixth gain having an input and an output, the input coupled to the output of the fourth analog integrator,
a sixth analog summer having a first input, a second input, and an output, the first input coupled to the output of the fifth analog summer, the second input coupled to the output of the fourth non-inverting gain amplifier, the output being the output of the loop filter and coupled to the input of the quantizer.

40. The system of claim 37, wherein
the loop filter of the single bit sigma delta modulator is a fourth order active filter.

41. The system of claim 40, wherein
the loop filter of the single bit sigma delta modulator includes
a second analog summer having a first input, a second input, and an output, the first input coupled to the output of the first analog summer,
a first analog integrator having an input and an output, the input coupled to the output of the second analog summer,
a second analog integrator having an input and an output, the input coupled to the output of the first analog integrator,
a third analog summer having a first input, a second input, and an output, the first input coupled to the output of the second analog integrator,
a third analog integrator having an input and an output, the input coupled to the output of the third analog summer,
a fourth analog integrator having an input and an output, the input coupled to the output of the third analog integrator,
a first inverting gain amplifier with a first gain having an input and an output, the input coupled to the output of the second analog integrator, the output coupled to the second input of the second analog summer,
a second inverting gain amplifier with a second gain having an input and an output, the input coupled to the output of the fourth analog integrator, the output coupled to the second input of the third analog summer,
a fourth analog summer having a first input, a second input, a third input, a fourth input, and an output, the output being the output of the loop filter and coupled to the input of the quantizer,
a third inverting gain amplifier with a third gain having an input and an output, the input coupled to the output of the first analog integrator, the output coupled to the first input of the fourth analog summer,
a fourth inverting gain amplifier with a fourth gain having an input and an output, the input coupled to the output of the second analog integrator, the output coupled to the second input of the fourth analog summer,
a fifth inverting gain amplifier with a fifth gain having an input and an output, the input coupled to the output of the third analog integrator, the output coupled to the third input of the fourth analog summer,
and
a sixth inverting gain amplifier with a sixth gain having an input and an output, the input coupled to the output of the fourth analog integrator, the output coupled to the fourth input of the fourth analog summer.

42. The system of claim 37, wherein
the processor includes
an input receiver coupled to the output driver of the radio frequency integrated circuit, the input receiver to receive the serial digital bit stream.

43. The system of claim 42, wherein
the processor is a digital signal processor and further includes
a sigma-delta digital modulator to generate a second serial digital bit stream from a digital signal for transmission, and
an output driver having an input and an output, the input coupled to an output of the sigma-delta digital modulator, the output driver to receive the second serial digital bit stream and drive it onto the output of the output driver.

44. The system of claim 42, wherein
the processor is a digital signal processor and further includes
a decimator coupled to the input receiver, the decimator to receive the serial digital bit stream, lower a sampling rate of the serial digital bit stream, and convert the serial digital bit stream into parallel digital data samples, and
a demodulator to digitally demodulate the parallel digital data samples into data words for further signal processing by the digital signal processing integrated circuit.

45. The system of claim 42, wherein
the processor includes programmable instructions to provide
a decimator coupled to the input receiver, the decimator to receive the serial digital bit stream, lower a sampling rate of the serial digital bit stream, and convert the serial digital bit stream into parallel digital data samples; and
a demodulator coupled to the decimator, the demodulator to digitally demodulate the parallel digital data samples into data words for further signal processing by the digital signal processing integrated circuit.

46. The system of claim 37, wherein
the processor is a digital signal processor and further includes
a sigma-delta digital modulator to generate a second serial digital bit stream from a digital signal for transmission, and
an output driver having an input and an output, the input coupled to an output of the sigma-delta digital modulator, the output driver to receive the second serial digital bit stream and drive it onto the output of the output driver.

47. The system of claim 46, wherein
the radio frequency integrated circuit further includes
an input receiver having an input and an output, the input coupled to the output of the output driver of the processor, the input receiver to receive the second serial digital bit stream;
a low pass filter having an input and an output, the input of the low pass filter coupled to the output of the input receiver, the low pass filter to convert the second serial digital bit stream into a second analog signal on the output of the low pass filter;
a mixer coupled having an input and an output, the input of the mixer coupled to the output of the low pass filter, the mixer to up-convert the second analog signal from a baseband frequency to a wireless network carrier frequency as the second wireless network radio signal on the output of the mixer; and
a second amplifier having an input and an output, the input of the second amplifier coupled to the output of the mixer, the second amplifier to amplify the second wireless network radio frequency signal onto the output of the second amplifier for radiation by an antenna.

48. The system of claim 37, wherein
the sigma-delta digital modulator includes
a first digital adder having a first digital input, a second digital input, and a digital output, the first digital input to receive a parallel digital word for transmission,
a digital loop filter having an input and an output, the input coupled to the output of the first digital adder,
a sign extractor having an input and an output, the input coupled to the output of the digital loop filter, the output coupled to the second input of the first digital adder, the sign extractor to generate the second serial bit stream on the output.

49. The system of claim 48, wherein
the sigma-delta digital modulator further includes
an inverter coupled having an input and an output, the input coupled to the output of the sign extractor, the output coupled to second input of the first digital adder.

50. The system of claim 49, wherein
the digital loop filter is a second order digital loop filter.

51. The system of claim 50, wherein
the digital loop filter includes
a second digital adder having a first input, a second input, and an output, the first input coupled to the output of the first digital adder,
a first digital delay register having an input and an output, the input coupled to the output of the second digital adder,
a first bit shifter having an input and an output, the input coupled to the output of the first digital delay register,
a second bit shifter having an input and an output, the input coupled to the output of the first digital delay register,
a second digital delay register having an input and an output, the input coupled to the output of the first digital delay register,
a first sign changer having an input and an output, the input coupled to the output of the second digital delay register,
a second sign changer having an input and an output, the input coupled to the output of the second digital delay register,
a third digital adder having a first input, a second input, and an output, the first input coupled to the output of the first bit shifter, the second input coupled to the output of the first sign changer, the output coupled to the second input of the second digital adder,
a fourth digital adder having a first input, a second input, and an output, the first input coupled to the output of the second bit shifter, the second input coupled to the output of the second sign changer, the output coupled to the input of the sign extractor.

52. The system of claim 46, wherein
the sigma-delta digital modulator includes
a first digital adder having a first digital input, a second digital input, a carry input, and a digital output, the first digital input to receive a parallel digital word for transmission,
a first digital delay register having an input and an output, the input coupled to the output of the first digital adder,
a first bit shifter having an input and an output, the input coupled to the output of the first digital delay register,
a second digital delay register having an input and an output, the input coupled to the output of the first digital delay register,
a first sign changer having an input and an output, the input coupled to the output of the second digital delay register,
a second digital adder having a first input, a second input, and an output, the first input coupled to the output of the first bit shifter, the second input coupled to the output of the first sign changer, the output coupled to the second input of the first digital adder,
a sign extractor having an input and an output, the input coupled to the output of the second digital adder, the sign extractor to generate the second serial bit stream on the output.
a second sign changer having an input and an output, the input coupled to the output of the sign extractor, the output coupled to the carry input of the first digital adder.

53. A wireless networking communication system comprising:
at least one wireless access point coupled to a wired network backbone, the at least one wireless access point having a first antenna to transmit and to receive wireless network signals within a limited area over at least one carrier frequency;
at least one wireless communication device to communicate with the at least one wireless access point using the wireless network signals, the at least one wireless communication device having
a second antenna to transmit and to receive the wireless network signals within the limited area,
a radio frequency integrated circuit coupled to the second antenna, the radio frequency integrated circuit including
a single bit sigma delta modulator with an analog input and a first serial digital output, the single bit sigma delta modulator to convert an analog input signal into a first serial digital bit stream,
a first output driver having an input coupled to the first serial digital output of the single bit sigma delta modulator, the first output driver having a differential output,
a first input receiver having a differential input to receive a second serial digital bit stream, and
a low pass filter coupled to an output of the first input receiver, the low pass filter to convert the second serial digital bit stream into an analog output signal;
and
a digital signal processing integrated circuit coupled to radio frequency integrated circuit, the digital signal processing integrated circuit including
a second input receiver having a differential input coupled to the differential output of the first output driver, the second input receiver to receive the first serial digital bit stream,
a single bit sigma delta digital modulator with a parallel digital input and a second serial digital output, the single bit sigma delta digital modulator to convert a digital word input signal into the second serial digital bit stream, and
a second output driver having an input coupled to the second serial digital output of the single bit sigma delta digital modulator, the second output driver having a differential output to couple to the differential input of the first input receiver.

54. The system of claim 53, wherein
to reduce noise,
the first output driver to drive the first serial digital bit stream out from the radio frequency integrated circuit to the digital signal processing integrated circuit with a low voltage differential output swing and
the second output driver to drive the second serial digital bit stream out from the the digital signal processing integrated circuit to the radio frequency integrated circuit with a low voltage differential output swing.

55. The system of claim 54, wherein
the first input receiver to receive the second serial digital bit stream with the low voltage differential output swing,
the second input receiver to receive the first serial digital bit stream with the low voltage differential output swing.

56. The system of claim 53, wherein
the digital signal processing integrated circuit further includes
a decimator coupled to the serial digital output of the second input receiver, the decimator having a parallel digital output, and
a demodulator coupled to the parallel digital output of the decimator.

57. The system of claim 53, wherein
the sigma-delta digital modulator includes
a first digital adder having a first digital input, a second digital input, and a digital output, the first digital input to receive a parallel digital word for transmission,
a digital loop filter having an input and an output, the input coupled to the output of the first digital adder,
a sign extractor having an input and an output, the input coupled to the output of the digital loop filter, the output coupled to the second input of the first digital adder, the sign extractor to generate the second serial bit stream on the output.

58. The system of claim 53, wherein
the single bit sigma delta modulator includes
an analog summer having a first input, a second input, and an output, the analog summer to sum the analog signals on the first input and the second input onto the output, the first input of the analog summer to receive the analog input signal from the wireless network;
a loop filter having an input and an output, the input of the loop filter coupled to the output of the analog summer;
a one bit quantizer having an input and an output, the input of the one bit quantizer coupled to the output of the loop filter;
a clocked sample and hold circuit having an input and an output, the input of the sample and hold circuit coupled to the output of the one bit quantizer, the output of the one bit quantizer coupled to the second input of the analog summer, the input of the sample and hold circuit being the output of the single bit sigma delta modulator.]
